(19) United States
(12) Patent Application Publication
(10) Pub. No.: US 2026/0009966 A1
(43) Pub. Date: Jan. 8, 2026

(54) LENS DRIVING DEVICE AND CAMERA MODULE

(71) Applicant: ALPS ALPINE CO., LTD., Tokyo (JP)

(72) Inventor: Takeshi MURAYAMA, Jiangsu (CN)

(21) Appl. No.: 19/244,093

(22) Filed: Jun. 20, 2025

(30) Foreign Application Priority Data
Jul. 2, 2024 (JP) 2024-107012

(51) Int. Cl. G02B 7/08

(52) U.S. Cl. CPC G02B 7/08

(57) ABSTRACT

A lens driving device includes a base member, a lens holding member having a tubular part configured to hold a lens system, and a shape memory alloy wire provided between the base member and the lens holding member and moving the lens holding member in an optical axis direction. The shape memory alloy wire has ends supported on the base member and the lens holding member, respectively. The base member has a guiding part that guides the lens holding member to move in the optical axis direction. The lens holding member has a guided part guided by the guiding part, and a pressing force acts on the guiding part and the guided part to press against each other due to contraction of the shape memory alloy wire in response to a current applied to the shape memory alloy wire, so that the guided part slides along the guiding part.

### CROSS-REFERENCE TO RELATED APPLICATIONS

This application is based upon and claims priority to Japanese Patent Application No. 2024-107012, filed on Jul. 2, 2024, the entire contents of which are incorporated herein by reference.

### BACKGROUND

### 1. Field of the Invention

The present disclosure relates to lens driving devices, and camera modules.

### 2. Description of the Related Art

There is a proposed lens driving device configured to move a lens holding member (or lens holder) in an optical axis direction with respect to a base member (or actuator base) using a shape memory alloy wire (refer to Japanese Laid-Open Patent Publication No. 2010-286820, for example).

However, in the proposed lens driving device, the lens holding member is simply held by a leaf spring. For this reason, it may be difficult to stably move the lens holding member along the optical axis direction.

Accordingly, there are demands to provide a lens driving device which can more stably move the lens holding member along the optical axis direction.

### SUMMARY

According to one aspect of embodiments of the present disclosure, a lens driving device includes a base member; a lens holding member having a tubular part configured to hold a lens system; and a shape memory alloy wire, provided between the base member and the lens holding member, configured to move the lens holding member in an optical axis direction, wherein the shape memory alloy wire has a first end supported on the base member and a second end supported on the lens holding member, so that the first end and the second end are located at different positions along the optical axis direction, the base member has a guiding part configured to guide the lens holding member to move in the optical axis direction, the lens holding member has a guided part guided by the guiding part, and a pressing force acts on the guiding part and the guided part to press against each other due to contraction of the shape memory alloy wire in response to a current applied to the shape memory alloy wire, so that the guided part slides along the guiding part.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a perspective view illustrating a camera module including a lens driving device according to one embodiment of the present disclosure;

FIG. 2 is a disassembled perspective view of the lens driving device illustrated in FIG. 1;

FIG. 3 is a perspective view illustrating a lens holding member, a metal member provided on the lens side, a leaf spring, and a magnetic member provided on the lens side;

FIG. 4 is a perspective view illustrating a base member, a metal member provided on the base side, a supported metal member, a metal member provided on the support side, the leaf spring, a flexible metal member, a receiving member, a flexible wiring board, an embedded member, and a magnetic member provided on the base side;

FIG. 5 is a bottom perspective view illustrating the base member, the supported metal member, the metal member provided on the support side, the flexible metal member, a support member, the flexible wiring board, the embedded member, a shape memory alloy wire, and a magnetic member provided on the support side;

FIG. 6 is a top view illustrating the lens holding member, the base member, the receiving member, and the embedded member;

FIG. 7 is a perspective view illustrating the metal member provided on the support side, the flexible metal member, the support member, the flexible wiring board, and the magnetic member provided on the support side;

FIG. 8 is a perspective view illustrating the metal member and the shape memory alloy wire;

FIG. 9 is a perspective view illustrating the metal member, the leaf spring, the flexible metal member, the flexible wiring board, the embedded member, and the shape memory alloy wire;

FIG. 10 is a perspective view illustrating the metal member provided on the base side, the metal member provided on the lens side, the leaf spring, the flexible wiring board, the embedded member, and the shape memory alloy wire;

FIG. 11 is a perspective view illustrating the supported metal member, the metal member provided on the support side, the flexible metal member, the flexible wiring board, the embedded member, and the shape memory alloy wire;

FIG. 12 is a three-side view illustrating the magnetic member provided on the lens side, the magnetic member provided on the base side, and the magnetic member provided on the support side; and

FIG. 13 is a perspective view illustrating the support member and the embedded member.

### DETAILED DESCRIPTION

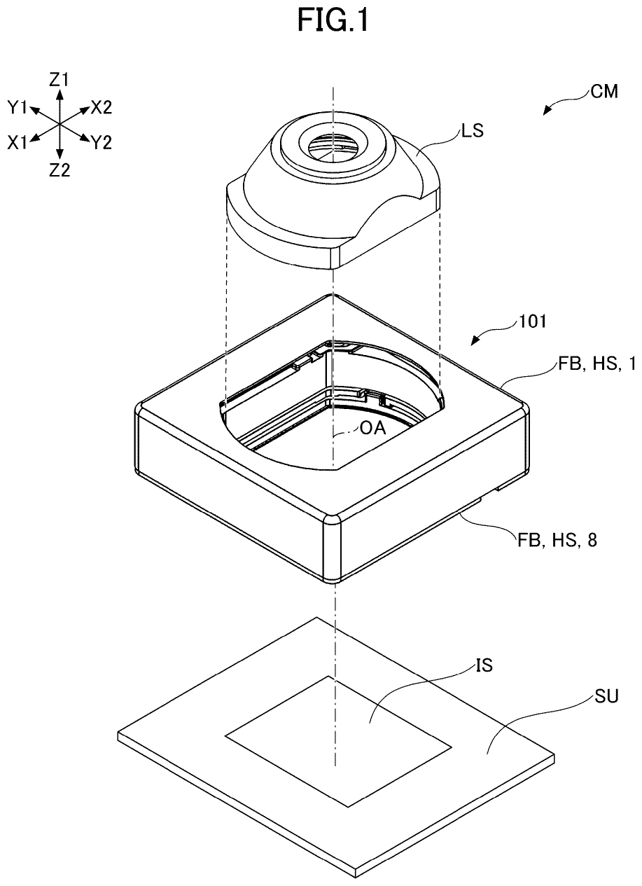

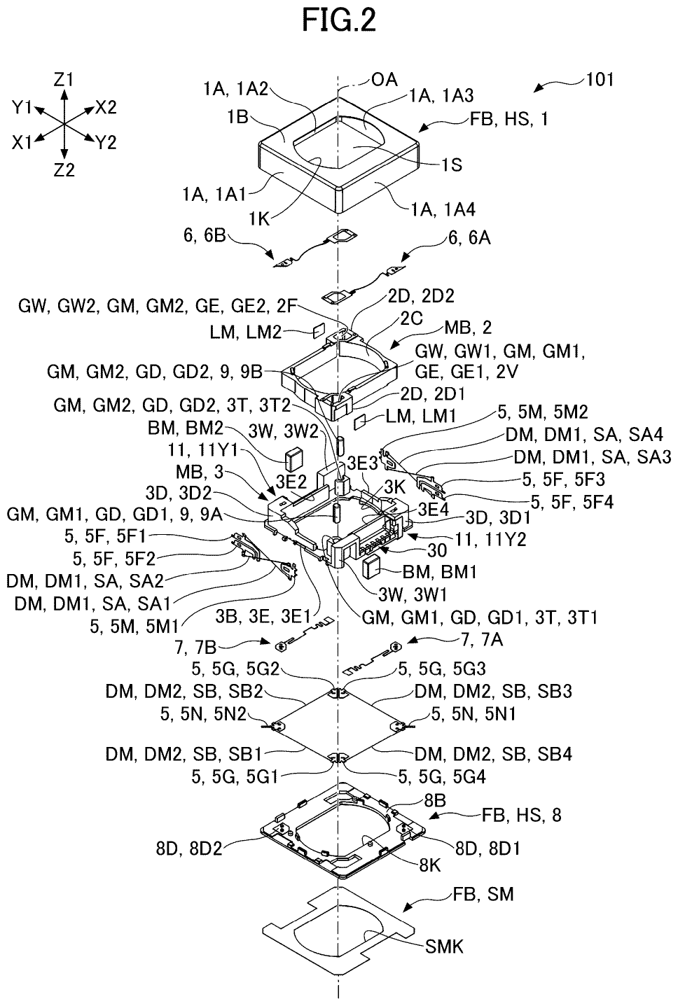

A lens driving device 101 according to one embodiment of the present disclosure will hereinafter be described with reference to the accompanying drawings. FIG. 1 is a perspective view illustrating a camera module CM including the lens driving device 101. FIG. 2 is a disassembled perspective view of the lens driving device 101.

In FIG. 1 and FIG. 2, X1 represents one direction along an X-axis forming a three-dimensional orthogonal coordinate system, and X2 represents another direction along the X-axis opposite to the X1 direction. In addition, Y1 represents one direction along a Y-axis forming the three-dimensional orthogonal coordinate system, and Y2 represents another direction along the Y-axis opposite to the Y1 direction. Similarly, Z1 represents one direction along a Z-axis forming the three-dimensional orthogonal coordinate system, and Z2 represents another direction along the Z-axis opposite to the Z1 direction. In FIG. 1 and FIG. 2, the X1-side of the lens driving device 101 corresponds to a front side (or a front area) of the lens driving device 101, and the X2-side of the lens driving device 101 corresponds to a rear side (or a rear area) of the lens driving device 101. In addition, the Y1-side of the lens driving device 101 corresponds to a left side of the lens driving device 101, and the Y2-side of the lens driving device 101 corresponds to a right side of the lens driving device 101. Further, the Z1-side of the lens driving device 101 corresponds to an upper side (or a subject side) of the lens driving device 101, and the Z2-side of the lens driving device 101 corresponds to a lower side (or an image sensor side) of the lens driving device 101. The same representations are used in each of the figures.

As illustrated in FIG. 1, the camera module CM is composed of a substrate SU, the lens driving device 101, a lens system LS provided on the lens driving device 101, and an image sensor IS provided on the substrate SU so as to oppose the lens system LS. In addition, the camera module CM is connected to a control device (not illustrated) composed of a microcomputer or the like including a central processing unit (CPU), a memory, or the like. The control device may be electronic circuitry (including a processor), such as a CPU, a graphics processing unit (GPU), a digital signal processor (DSP), a field programmable gate array (FPGA), an application specific integrated circuit (ASIC), or the like. The electronic circuitry performs the processes of the control device described in the present specification by executing instruction codes or command codes stored in a memory, or by being designed for specialized circuit applications or specific purposes. In the illustrated example, the control device is provided outside the camera module CM, but the control device may be provided inside the camera module CM. The lens driving device 101 has an approximately parallelepiped outer shape, and is provided on the substrate SU implemented with the image sensor IS, as illustrated in FIG. 1.

Particularly, the lens driving device 101 includes a cover member 1 and a support member 8, which are portions of a fixed member FB, as illustrated in FIG. 1 and FIG. 2. The cover member 1 is composed so as to function as a portion of a housing HS of the lens driving device 101. In the illustrated example, the cover member 1 is formed of a nonmagnetic metal. However, the cover member 1 may be formed of a magnetic metal.

Particularly, the cover member 1 has a bottomless box outer shape defining an accommodating part 15. That is, the cover member 1 includes an outer peripheral wall 1A with a rectangular tube shape, and a flat top plate 1B with a rectangular annular shape. The top plate 1B is provided so as to be continuous with an upper end (an end on the Z1-side) of the outer peripheral wall 1A. An opening 1K having a rounded rectangular shape is formed in a center of the top plate 1B. The outer peripheral wall 1A includes first through fourth plate portions 1A1 through 1A4. The first and third plate portions 1A1 and 1A3 oppose each other, and the second and fourth plate portions 1A2 and 1A4 oppose each other. The first and third plate portions 1A1 and 1A3 extend perpendicularly to the second and fourth plate portions 1A2 and 1A4. The cover member 1 and the support member 8 are connected to each other using an adhesive, thereby forming the housing HS, as illustrated in FIG. 1. Moreover, a magnetic member SM provided on the support side (hereinafter also referred to as “a support-side magnetic member SM”) is connected to a lower surface of the support member 8 using an adhesive.

As illustrated in FIG. 2, a lens holding member (or a lens holder) 2, a base member 3, a metal member 5, a leaf spring (or a plate spring) 6, a flexible metal member 7, a receiving member 9, a flexible wiring board 11, an embedded member 30, a magnetic member BM provided on the base side (hereinafter also referred to as “a base-side magnetic member BM”), a magnetic member LM provided on the lens side (hereinafter also referred to as “a lens-side magnetic member LM”), a shape memory alloy wire SA, a shape memory alloy wire SB, or the like are accommodated between the cover member 1 and the support member 8.

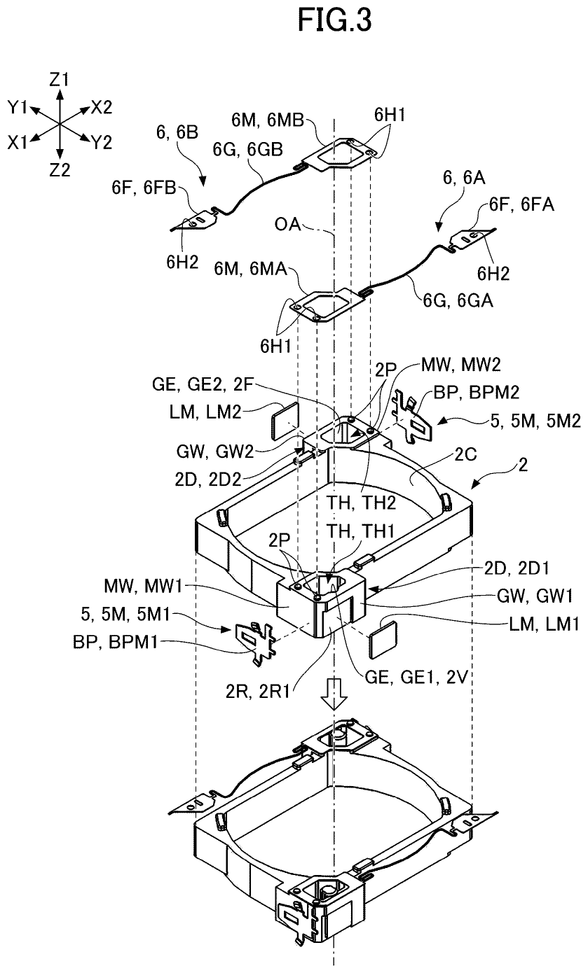

FIG. 3 is a perspective view illustrating the lens holding member 2, a metal member 5M provided on the lens side (hereinafter also referred to as “a lens-side metal member 5M”), the leaf spring 6, and the lens-side magnetic member LM. Particularly, an upper portion of FIG. 3 above a downward pointing block arrow is a disassembled perspective view, and a lower portion of FIG. 3 below the downward pointing block arrow is an assembly perspective view.

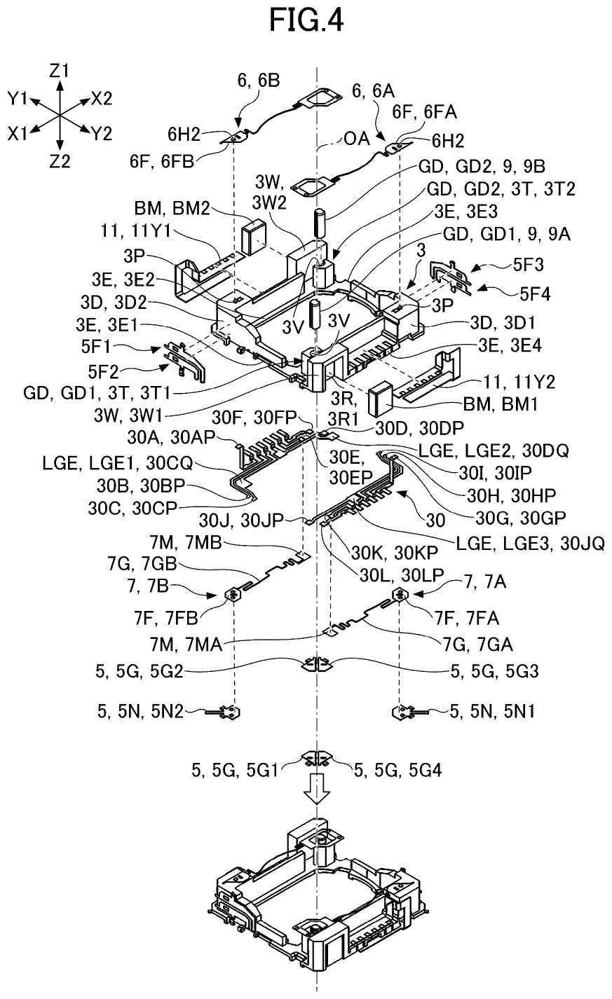

FIG. 4 is a perspective view illustrating the base member 3, a metal member 5F provided on the base side (hereinafter also referred to as “a base-side metal member 5F), a supported metal member 5G, a metal member 5N provided on the support side (hereinafter also referred to as a support-side metal member 5N”), the leaf spring 6, the flexible metal member 7, the receiving member 9, the flexible wiring board 11, the embedded member 30, and the base-side magnetic member BM. Particularly, an upper portion of FIG. 4 above a downward pointing block arrow is a disassembled perspective view, and a lower portion of FIG. 4 below the downward pointing block arrow is an assembled perspective view.

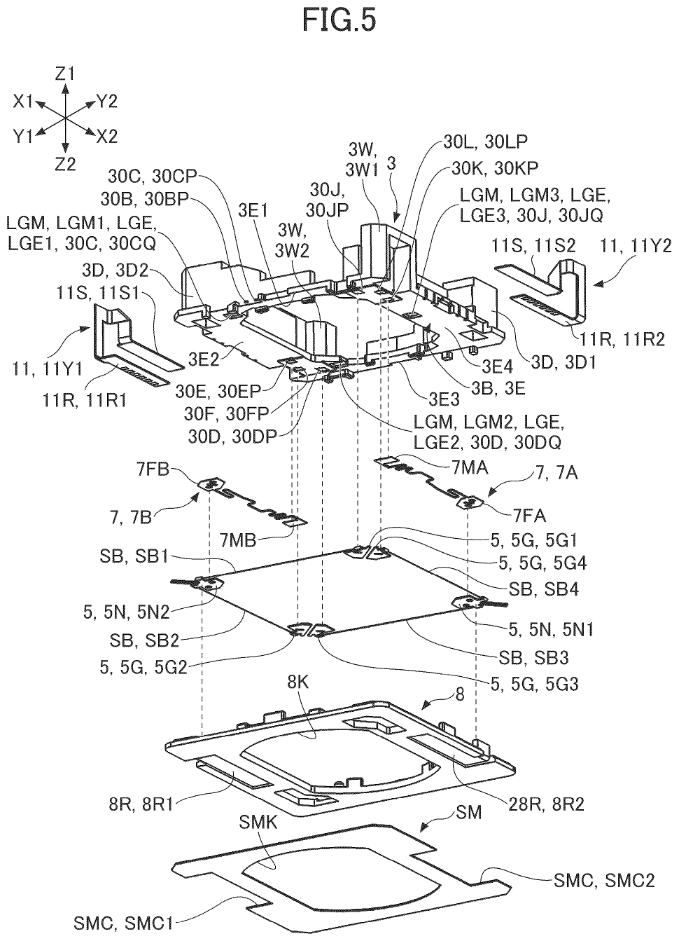

FIG. 5 is a bottom perspective view illustrating the base member 3, the supported metal member 5G, the support-side metal member 5N, the flexible metal member 7, the support member 8, the flexible wiring board 11, the embedded member 30, the shape memory alloy wire SB, and the support-side magnetic member SM.

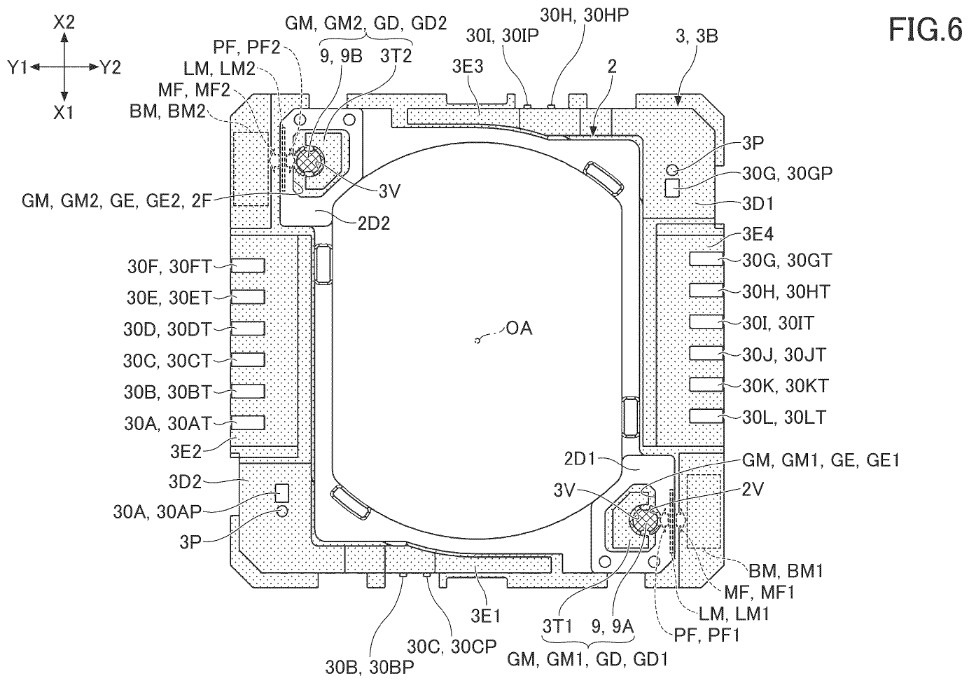

FIG. 6 is a top view illustrating the lens holding member 2, the base member 3, the receiving member 9, and the embedded member 30. In order to facilitate identification, a dot pattern is added to the base member 3 in FIG. 6, and a cross pattern is added to the receiving member 9.

The lens holding member 2 is capable of holding the lens system LS illustrated in FIG. 1, and constitutes a movable member MB. The lens system LS is a lens body, a lens assembly, or the like composed of a tubular lens barrel having at least one lens, for example, and a central axis line of the lens system LS extends along an optical axis QA.

In the illustrated example, the lens holding member 2 is formed by injection molding of a synthetic resin, such as a liquid crystal polymer (LCP) or the like. Particularly, the lens holding member 2 includes a tubular part 2C formed to extend along the optical axis QA, and a pedestal 2D formed to protrude from the tubular part 2C in an outward radial direction of a circle having the optical axis QA as a center thereof. The pedestal 2D includes a first pedestal portion 2D1, and a second pedestal portion 2D2. The first pedestal portion 2D1 and the second pedestal portion 2D2 are arranged to extend in mutually opposite directions along a radial direction (a diagonal direction), with the optical axis QA arranged between the first pedestal portion 2D1 and the second pedestal portion 2D2. In addition, a portion of one leaf spring 6 is placed on an upper surface of the first pedestal portion 2D1, and a portion of another leaf spring 6 is placed on an upper surface of the second pedestal portion 2D2.

As illustrated in FIG. 3, the pedestal 2D includes an attachment wall MW where the lens-side metal member 5M is attached, and a guided wall GW formed along a plane (an XZ-plane) intersecting (approximately perpendicular to) a plane (a YZ-plane) along a plate surface of a base BP of the lens-side metal member 5M. A part of a guide mechanism GM, which guides a movement of the lens holding member 2 with respect to the base member 3 in the optical axis direction, is provided on the guided wall GW. A guided part GE, which is a part of the guide mechanism GM, is formed on an inner surface of the guided wall GW, and the lens-side magnetic member LM is fixed in a recess 2R formed in an outer surface of the guided wall GW. Particularly, the first pedestal portion 2D1 includes a first attachment wall portion MW1 where a first metal member 5M1 provided on the lens side (hereinafter also referred to as “a first lens-side metal member 5M1”) is attached, and a first guided wall portion GW1 formed along a plane (the XZ-plane) intersecting (approximately parallel to) a plane (the YZ-plane) along a plate surface of a base portion BPM1 of the first lens-side metal member 5M1. A portion of a first guide mechanism GM1 is provided on the first guided wall portion GW1. A first guided portion GE1, which is a portion of the first guide mechanism GM1, is formed on an inner surface of the first guided wall portion GW1, and a first magnetic member LM1 provided on the lens side (hereinafter also referred to as “a first lens-side magnetic member LM1”) is bonded to and fixed in a first recess 2R1 formed in an outer surface of the first guided wall portion GW1. Similarly, the second pedestal portion 2D2 includes a second attachment wall portion MW2 where a second metal member 5M2 provided on the lens side (hereinafter also referred to as “a second lens-side metal member 5M2”) is attached, and a second guided wall portion GW2 formed along a plane (the XZ-plane) intersecting (approximately parallel to) a plane (the YZ-plane) along a plate surface of a base portion BPM2 of the second lens-side metal member 5M2. A portion of a second guide mechanism GM2 is provided on the second guided wall portion GW2. A second guided portion GE2, which is a portion of the second guide mechanism GM2, is formed on an inner surface of the second guided wall portion GW2, and a second magnetic member LM2 provided on the lens side (hereinafter also referred to as “a second lens-side magnetic member LM2”) is bonded to and fixed in a second recess (not visible in FIG. 3) formed in an outer surface of the second guided wall portion GW2.

In the illustrated example, the guided part GE constitutes the guide mechanism GM together with a guiding part GD which will be described later. Particularly, the first guided portion GE1 constitutes the first guide mechanism GM1 together with a first guide portion GD1, and the second guided portion GE2 constitutes the second guide mechanism GM2 together with a second guide portion GD2. In addition, the first guided portion GE1 includes a groove portion 2V which is a V-shaped groove extending in the optical axis direction, and is configured to make contact at two positions with a circumferential surface of the receiving member 9 (a first receiving member 9A) having an approximately cylindrical shape. On the other hand, the second guided portion GE2 includes a flat portion 2F extending in the optical axis direction, and is configured to make contact at one position with the circumferential surface of the receiving member 9 (a second receiving member 9B) having the approximately cylindrical shape. According the configuration described above, the guide mechanism GM can prevent the lens holding member 2 from moving unintentionally in the X-axis direction and the Y-axis direction with respect to the base member 3.

A driving part DM is configured to be able to move the movable member MB with respect to the fixed member FB. In the illustrated example, the driving part DM includes the shape memory alloy wires which are examples of shape memory actuators. Particularly, as illustrated in FIG. 2, the driving part DM includes a first driving portion DM1 configured to move the lens holding member 2 with respect to the base member 3, and a second driving portion DM2 configured to move the base member 3 with respect to the support member 8. The first driving portion DM1 includes the shape memory alloy wire SA, and the second driving portion DM2 includes the shape memory alloy wire SB. The shape memory alloy wire SA includes first through fourth wires SA1 through SA4, and the shape memory alloy wire SB includes first through fourth wires SB1 through SB4.

The shape memory alloy wire is configured to contract according to a temperature rise when the temperature thereof rises due to a current supplied thereto. Particularly, the shape memory alloy wire SA is provided so as to stretch linearly along an inner surface of outer peripheral wall 1A of the cover member 1 when the current is supplied to the shape memory alloy wire SA, and is configured to be able to move the lens holding member 2 with respect to the base member 3 in a direction (the Z-axis direction) parallel to the optical axis QA. Further, each wire of the first through fourth wires SA1 through SA4 has a first end fixed to the base-side metal member 5F by crimping, soldering, or the like, and a second end fixed to the metal member 5M on the lens-side by crimping, soldering, or the like. The shape memory alloy wire SB is provided so as to stretch linearly along each side of the support member 8 when the current is supplied to the shape memory alloy wire SB, and is configured to be able to move the base member 3 with respect to the support member 8 in directions (the X-direction and the Y-direction) perpendicular to the optical axis QA. Moreover, each wire of the first through fourth wires SB1 through SB4 has a first end fixed to the support-side metal member 5N by crimping, soldering, or the like, and a second end fixed to the supported metal member 5G by crimping, soldering, or the like.

In the illustrated example, the first wire SA1 and the second wire SA2 are arranged to cross each other without contacting each other, at a front side (the X1-side) of the lens holding member 2 and the base member 3. The third wire SA3 and the fourth wire SA4 are arranged to cross each other without contacting each other, at a rear (the X2-side) of the lens holding member 2 and the base member 3.

The first driving portion DM1 can move the lens holding member 2 up and down along the optical axis direction (the Z-axis direction) parallel to the optical axis QA, utilizing the contraction of the shape memory alloy wire SA. The shape memory alloy wire SA is configured so that the lens holding member 2 moves when one or more wires of the first through fourth wires SA1 through SA4 contract, and this movement causes the other one or more wires of the first through fourth wires SA1 through SA4 to expand. Similarly, the second driving portion DM2 can move the base member 3 (including the lens holding member 2) back and forth along a first direction (the X-axis direction) perpendicular to the optical axis QA, utilizing the contraction of the shape memory alloy wire SB, and move the base member 3 (including the lens holding member 2) right and left along a second direction (the Y-axis direction) perpendicular to each of the optical axis QA and the first direction. The shape memory alloy wire SB is configured so that the base member 3 moves when one or more wires of the first through fourth wires SB1 through SB4 contract, and this movement causes the other one or more wires of the first through fourth wires SB1 through SB4 to expand.

The base member 3 is movable in each of the X-axis direction and the Y-axis direction, with respect to the fixed member FB (the support member 8), and constitutes the movable member MB. In the illustrated example, the base member 3 is formed by injection molding of a synthetic resin, such as a liquid crystal polymer (LCP) or the like. Particularly, the base member 3 has an approximately rectangular outer shape in a plan view (a top view), and includes an opening 3K having an approximately rounded rectangular shape at a center thereof. Further, the base member 3 includes a main body 3B with a rectangular annular shape surrounding the opening 3K, a pedestal 3D protruding upward from the main body 3B, a projection 3T, and an outer wall 3W. The pedestal 3D includes a first pedestal portion 3D1 and a second pedestal portion 3D2. The projection 3T includes a first projecting portion 3T1 and a second projecting portion 3T2. The outer wall 3W includes a first outer wall portion 3W1 and a second outer wall portion 3W2. The first pedestal portion 3D1 and the second pedestal portion 3D2 are arranged to oppose each other in one diagonal direction, with the optical axis QA arranged between the first pedestal portion 3D1 and the second pedestal portion 3D2. The first projecting portion 3T1 and the second projecting portion 3T2 are arranged to oppose each other in the other diagonal direction, with the optical axis QA arranged between the first projecting portion 3T1 and the second projecting portion 3T2. The first outer wall portion 3W1 and the second outer wall portion 3W2 are arranged to oppose each other in the other diagonal direction, with the optical axis QA arranged between the first outer wall portion 3W1 and the second outer wall portion 3W2. More particularly, the main body 3B is configured to include four sides 3E (first through fourth sides 3E1 through 3E4), and the first projecting portion 3T1 and the first outer wall portion 3W1 are provided between the fourth side 3E4 and the first side 3E1, and the second pedestal portion 3D2 is provided between the first side 3E1 and the second side 3E2. In addition, the second projecting portion 3T2 and the second outer wall portion 3W2 are provided between the second side 3E2 and the third side 3E3, and the first pedestal portion 3D1 is provided between the third side 3E3 and the fourth side 3E4. Moreover, a portion of one leaf spring 6 is placed on an upper surface of the first pedestal portion 3D1, and a portion of the other leaf spring 6 is placed on an upper surface of the second pedestal portion 3D2. Further, one base-side metal member 5F is attached to a side surface of the first pedestal portion 3D1, and the other base-side metal member 5F is attached to a side surface of the second pedestal portion 3D2.

As illustrated in FIG. 4, the base-side magnetic member BM is fixed in the recess 3R formed in the outer surface of the outer wall 3W. Particularly, a first magnetic member BM1 provided on the base side (hereinafter also referred to as “a first base-side magnetic member BM1”) is bonded to and fixed in a first recess 3R1 formed in a right surface of the first outer wall portion 3W1. Similarly, a second magnetic member BM2 provided on the base side (hereinafter also referred to as “a second base-side magnetic member BM2”) is bonded to and fixed in a second recess (not visible in FIG. 4) formed in a left surface of the second outer wall portion 3W2.

The projection 3T constitutes the guiding part GD together with the receiving member 9. Further, the guiding part GD constitutes the guide mechanism GM together with the guided part GE.

The base-side magnetic member BM cooperates with each of the lens-side magnetic member LM fixed to the lens holding member 2, and the support-side magnetic member SM fixed to the support member 8, and is configured to prevent the base member 3 from separating from each of the lens holding member 2 and the support member 8. Particularly, as illustrated in FIG. 2, the base-side magnetic member BM is bonded to and fixed on the base member 3, so as to be magnetically attracted to the lens-side magnetic member LM bonded to and fixed on the lens holding member 2, and to be magnetically attracted to the support-side magnetic member SM bonded to and fixed on the support member 8. In the illustrated example, the base-side magnetic member BM is a permanent magnet magnetized along the Z-axis direction in a bipolar manner, and includes the first base-side magnetic member BM1 and the second base-side magnetic member BM2.

The metal member 5 is configured so that a part of the shape memory alloy wire is fixed thereto. In the illustrated example, the metal member 5 is formed of a nonmagnetic metal, and includes the base-side metal member 5F, the lens-side metal member 5M, the supported metal member 5G, and the support-side metal member 5N, as illustrated in FIG. 2. The base-side metal member 5F is configured to be fixed to a side surface of the pedestal 3D of the base member 3. The lens-side metal member 5M is configured to be fixed to a side surface of the pedestal 2D of the lens holding member 2. The supported metal member 5G is fixed to a lower surface of the base member 3. The support-side metal member 5N is configured to be fixed to an upper surface of the support member 8. The base-side metal member 5F may be embedded in the pedestal 3D of the base member 3, and the lens-side metal member 5M may be embedded in the pedestal 2D of the lens holding member 2. In addition, the supported metal member 5G may be embedded in the base member 3, and the support-side metal member 5N may be embedded in the support member 8.

More particularly, the base-side metal member 5F includes first through fourth base-side metal members 5F1 through 5F4, and the lens-side metal member 5M includes a first lens-side metal member 5M1 and a second lens-side metal member 5M2. The supported metal member 5G includes first through fourth supported metal members 5G1 through 5G4, and the support-side metal member 5N includes a first support-side metal member 5N1 and a second support-side metal member 5N2.

The leaf spring 6 is configured to movably support the lens holding member 2 so that the lens holding member 2 is movable with respect to the base member 3 in a direction parallel to the optical axis OA. In the present embodiment, the leaf spring 6 is formed of a metal plate mainly made of a copper alloy, a titanium copper-based alloy (titanium copper), a copper-nickel alloy (nickel-tin-copper), or the like, for example. In the illustrated example, the leaf spring 6 connects the lens holding member 2 and the base member 3 so that a center of the lens holding member 2 and a center of the base member 3 coincide in a neutral state of the lens driving device 101. That is, the leaf spring 6 is configured to be able to center the lens holding member 2 with respect to the base member 3 on the XY-plane. Particularly, the leaf spring 6 is configured to connect the pedestal 2D (the first pedestal portion 2D1 and the second pedestal portion 2D2) formed on the lens holding member 2 and the pedestal 3D (the first pedestal portion 3D1 and the second pedestal portion 3D2) formed on the base member 3. The neutral state of the lens driving device 101 is a state in which a current is supplied to each of the first through fourth wires SA1 through SA4 and to each of the first through fourth wires SB1 through SB4, and in this neutral state, the movable member MB (the lens holding member 2 and the base member 3) is located in a middle of a movable range along each of the three mutually perpendicular axes (the X-axis, the Y-axis, and the Z-axis). That is, in the neutral state of the lens driving device 101, the movable member MB (the lens holding member 2 and the base member 3) is in a neutral position thereof. Typically, in the neutral state of the lens driving device 101, the lens holding member 2 is located at a center of a movable range along each of the three axes, and the base member 3 is located at a center of the movable range along each of the two axes (the X-axis and the Y-axis).

In addition, the leaf spring 6 also functions as a member for supplying a current to the shape memory alloy wire SA. Particularly, as illustrated in FIG. 3, the leaf spring 6 includes a joint portion 6F provided on the base side (hereinafter also referred to as “a base-side joint portion 6F”) fixed to the base member 3, a joint portion 6M provided on the lens side (hereinafter also referred to as “a lens-side joint portion 6M”) fixed to the lens holding member 2, and an elastic arm 6G which is elastically deformable and connects the base-side joint portion 6F and the lens-side joint portion 6M. In the illustrated example, the leaf spring 6 includes a first leaf spring 6A and a second leaf spring 6B. The first leaf spring 6A includes a first base-side joint portion 6FA, a first lens-side joint portion 6MA, and a first elastic arm portion 6GA. The second leaf spring 6B includes a second base-side joint portion 6FB, a second lens-side joint portion 6MB, and a second elastic arm portion 6GB.

The flexible metal member 7 functions as a member for supplying a current to the shape memory alloy wire SB. Particularly, as illustrated in FIG. 4, the flexible metal member 7 includes a fixed joint portion 7F fixed to the support member 8, a movable joint portion 7M fixed to the base member 3, and an elastic arm 7G which is elastically deformable and connects the fixed joint portion 7F and the movable joint portion 7M. In the illustrated example, the flexible metal member 7 includes a first flexible metal member 7A and a second flexible metal member 7B. The first flexible metal member 7A includes a first fixed joint portion 7FA, a first movable joint portion 7MA, and a first elastic arm portion 7GA. The second flexible metal member 7B includes a second fixed joint portion 7FB, a second movable joint portion 7MB, and a second elastic arm portion 7GB.

The support member 8 is configured to support the movable member MB, and constitutes the fixed member FB. In the illustrated example, the support member 8 is formed by injection molding of a synthetic resin, such as a liquid crystal polymer (LCP) or the like. Particularly, as illustrated in FIG. 2, the support member 8 has an approximately rectangular outer shape in the plan view (the top view), and includes an opening 8K having an approximately rounded rectangular shape at a center thereof. In addition, the support member 8 includes a rectangular annular base portion 8B formed so as to surround the opening 8K.

The support member 8 has a pedestal 8D to which the support-side metal member 5N is attached. In the illustrated example, the support member 8 includes a first pedestal portion 8D1 on which the first support-side metal member 5N1 is placed, and a second pedestal portion 8D2 on which the second support-side metal member 5N2 is placed.

The receiving member 9 constitutes the guiding part GD together with the projection 3T of the base member 3. The guide portion GD constitutes the guide mechanism GM for guiding the movement of the lens holding member 2 with respect to the base member 3 in the optical axis direction, together with the guided part GE. In the illustrated example, the receiving member 9 is a cylindrical member formed of a metal as illustrated in FIG. 2, and includes the first receiving member 9A constituting the first guide portion GD1, and a second receiving member 9B constituting the second guide portion GD2.

Particularly, the guide mechanism GM includes the first guide mechanism GM1 and the second guide mechanism GM2. The first guide mechanism GM1 is configured by the first guide portion GD1 and the first guided portion GE1, and the second guide mechanism GM2 is configured by the second guide portion GD2 and the second guided portion GE2. The first guide portion GD1 is constituted by the first projecting portion 3T1 and the first receiving member 9A, and the second guide portion GD2 is constituted by a second projecting portion 3T2 and the second receiving member 9B. In the illustrated example, the first receiving member 9A is fitted into a U-shaped groove 3V, formed in the first projecting portion 3T1 and extending along the optical axis direction, and is bonded to and fixed in the U-shaped groove 3V. The second receiving member 9B is fitted into a U-shaped groove 3V, formed in the second projecting portion 3T2 and extending along the optical axis direction, and is bonded to and fixed in the U-shaped groove 3V. The lens holding member 2 is arranged so that the first guided portion GE1 (the groove portion 2V) slides on the surface of the first receiving member 9A, and the second guided portion GE2 (the flat portion 2F) slides on the surface of the second receiving member 9B.

The receiving member 9 may be formed integrally with the projection 3T of the base member 3. That is, the receiving member 9 may be a part of the projection 3T that is formed of a synthetic resin.

Alternatively, the receiving member 9 may constitute the guided part GE together with the guided wall GW of the lens holding member 2. In this case, the receiving member 9 is bonded to and fixed on the inner surface of the guided wall GW, and the base member 3 is arranged so that the receiving member 9, functioning as the guided part GE, slides on the surface of the projection 3T. Alternatively, the receiving member 9 may be formed integrally with the guided wall GW. That is, the receiving member 9 may be a part of the guided wall GW that us formed of a synthetic resin.

The flexible wiring board 11 includes a conductive pattern, and is configured to be able to electrically connect an external current supply source (a control circuit) and a shape memory alloy wire. In the illustrated example, the flexible wiring board 11 includes a first flexible wiring board 11Y1 and a second flexible wiring board 11Y2 as illustrated in FIG. 2, and is configured to be able to supply a current to the shape memory alloy wire.

The lens-side magnetic member LM is a member for positioning the lens holding member 2 at a predetermined position with respect to the base member 3. Particularly, the lens-side magnetic member LM is attached to the lens holding member 2 so that the lens holding member 2 (the lens-side magnetic member LM) is attracted to the base member 3 (the base-side magnetic member BM) due to a magnetic attraction force acting between the lens-side magnetic member LM and the base-side magnetic member BM fixed to the base member 3, and the lens holding member 2 is centered on the XY-plane. In the illustrated example, the lens-side magnetic member LM is a metal plate formed of a magnetic metal, and includes the first lens-side magnetic member LM1 and the second lens-side magnetic member LM2. However, the lens-side magnetic member LM may be a magnet, or may be formed of a magnetic resin material or the like as long as a magnetic attraction force can be generated between the lens-side magnetic member LM and the base-side magnetic member BM.

The embedded member 30 is a metal member embedded in the base member 3. Particularly, the embedded member 30 includes a bonding portion exposed at the surface of the base member 3 and used for bonding the embedded member 30 to the metal member 5 or the flexible metal member 7. In the illustrated example, the embedded member 30 includes first through twelfth embedded members 30A through 30L as illustrated in FIG. 4.

The support-side magnetic member SM cooperates with the base-side magnetic member BM fixed to the base member 3, and is configured to prevent the base member 3 from separating from the support member 8. In the illustrated example, the support-side magnetic member SM is a flat metal plate having an rectangular annular shape formed of a magnetic metal. However, the support-side magnetic member SM may be a magnet, or may be formed of a magnetic resin material or the like as long as a magnetic attraction force can be generated between the support-side magnetic member SM and the base-side magnetic member BM. In addition, the support-side magnetic member SM may be embedded in the support member 8 by insert molding or the like. Particularly, as illustrated in FIG. 2, the support-side magnetic member SM has an approximately rectangular outer shape in the plan view (the top view), and includes an opening SMK having an approximately rounded rectangular shape at a center thereof.

Next, a positional relationship between a member attached to the lens holding member 2, and the lens holding member 2 will be described with reference to FIG. 3 and FIG. 4.

In the example illustrated in FIG. 3, the first lens-side metal member 5M1 is fixed to a front surface of the first pedestal portion 2D1 (the first attachment wall portion MW1 which is a portion on the front side (the X1-side) of the first pedestal portion 2D1). Particularly, the first lens-side metal member 5M1 is fixed to the first pedestal portion 2D1 using an adhesive. The adhesive is a photo-curing adhesive, for example. The photo-curing adhesive is an ultraviolet-curing adhesive, a visible light-curing adhesive, or the like, for example. Similarly, the second lens-side metal member 5M2 is fixed to the rear surface of the second pedestal portion 2D2 (the second attachment wall portion MW2 which is a portion on the rear side (the X2-side) of the second pedestal portion 2D2). The lens-side metal member 5M may be fixed to the pedestal 2D by staking (caulking) or the like.

The first lens-side magnetic member LM1 is bonded to and fixed in the first recess 2R1 formed in the right side surface of the first pedestal portion 2D1 (the first guided wall portion GW1 which is a portion on the right side (the Y2-side) of the first pedestal portion 2D1). Similarly, the second lens-side magnetic member LM2 is bonded to and fixed in the second recess (not visible in FIG. 3) formed in the left side surface of the second pedestal portion 2D2 (the second guided wall portion GW2 which is a portion on the left side (the Y1-side) of the second pedestal portion 2D2).

The leaf spring 6 includes the base-side joint portion 6F fixed to the pedestal 3D (refer to FIG. 2) of the base member 3, the lens-side joint portion 6M fixed to the pedestal 2D of the lens holding member 2, and the elastic arm 6G connecting the base-side joint portion 6F and the lens-side joint portion 6M. Particularly, the leaf spring 6 includes the first leaf spring 6A and the second leaf spring 6B. The first leaf spring 6A includes the first base-side joint portion 6FA, the first lens-side joint portion 6MA, and the first elastic arm portion 6GA connecting the first base-side joint portion 6FA and the first lens-side joint portion 6MA. Similarly, the second leaf spring 6B includes the second base-side joint portion 6FB, the second lens-side joint portion 6MB, and the second elastic arm portion 6GB connecting the second base-side joint portion 6FB and the second lens-side joint portion 6MB.

As illustrated in FIG. 3, the first lens-side joint portion 6MA has a first through hole 6H1 through which a round projection 2P formed on the upper surface of the first pedestal portion 2D1 and projecting upward is inserted. The second lens-side joint portion 6MB has a first through hole 6H1 through which a round projection 2P formed on the upper surface of the second pedestal portion 2D2 and projecting upward is inserted. In the illustrated example, the leaf spring 6 and the projection 2P are connected using an adhesive. However, the connection between the leaf spring 6 and the projection 2P may be achieved by performing a hot staking or a cold staking on the projection 2P.

As illustrated in FIG. 4, the first base-side joint portion 6FA has a second through hole 6H2 through which a round projection 3P formed on the upper surface of the first pedestal portion 3D1 and projecting upward is inserted. In addition, the second base-side joint portion 6FB has a second through hole 6H2 through which a round projection 3P formed on the upper surface of the second pedestal portion 3D2 and projecting upward is inserted. In the illustrated example, the leaf spring 6 and the projection 3P are connected using an adhesive. However, the connection between the leaf spring 6 and the projection 3P may be achieved by performing a hot staking or a cold staking on the projection 3P.

The first leaf spring 6A and the second leaf spring 6B are arranged to have a two-fold rotational symmetry with respect to the optical axis OA, as illustrated in FIG. 3. For this reason, the first leaf spring 6A and the second leaf spring 6B can support the lens holding member 2 in the air with a good balance. Further, the first leaf spring 6A and the second leaf spring 6B do not adversely affect a weight balance of the lens holding member 2 supported by the four shape memory alloy wires SA (the first through fourth wires SA1 through SA4).

Next, a positional relationship between a member contacting the base member 3, and the base member 3 will be described with reference to FIG. 4, FIG. 5, and FIG. 6.

As illustrated in FIG. 4, the base-side metal member 5F is fixed to the outer surface of the pedestal 3D of the base member 3. Particularly, the first base-side metal member 5F1 and the second base-side metal member 5F2 are fixed to the front surface of the second pedestal portion 3D2 of the base member 3, and the third base-side metal member 5F3 and the fourth base-side metal member 5F4 are fixed to the rear surface of the first pedestal portion 3D1 of the base member 3.

The embedded member 30 is embedded in the base member 3 so that a portion of the embedded member 30 is exposed at the surface of the base member 3. Particularly, as illustrated in FIG. 6, the first through sixth embedded members 30A through 30F are embedded in the base member 3 in a state where first through sixth terminal portions 30AT through 30FT are exposed at the upper surface of the second side portion 3E2 of the base member 3, respectively. The seventh through twelfth embedded members 30G through 30L are embedded in the base member 3 in a state where the seventh through twelfth terminal portions 30GT through 30LT are exposed at the upper surface of the fourth side portion 3E4 of the base member 3, respectively. In addition, as illustrated in FIG. 6, the first embedded member 30A exposes the first joint portion 30AP from the upper surface of the second pedestal portion 3D2, the second embedded member 30B exposes a second joint portion 30BP from the front surface of the first side portion 3E1, the third embedded member 30C exposes the third joint portion 30CP from the front surface of the first side portion 3E1, the seventh embedded member 30G exposes a seventh joint portion 30GP from the upper surface of the first pedestal portion 3D1, the eighth embedded member 30H exposes the eighth joint portion 30HP from the rear surface of the third side portion 3E3, and the ninth embedded member 30I exposes the ninth joint portion 30IP from the rear surface of the third side portion 3E3. Moreover, as illustrated in FIG. 5, the fourth through sixth embedded members 30D through 30F expose the fourth through sixth joint portions 30DP through 30FP from the lower surface of the left rear corner portion of the main body 3B of the base member 3, respectively, and the tenth through twelfth embedded members 30J through 30L expose the tenth through twelfth joint portions 30JP through 30LP from the lower surface of the right front corner portion of the main body 3B of the base member 3, respectively.

The first supported metal member 5G1 is fixed to the lower surface of the right front corner portion of the main body 3B of the base member 3, and is connected to the tenth joint portion 30JP. The second supported metal member 5G2 is fixed to the lower surface of the left rear corner portion of the main body 3B of the base member 3, and is connected to the sixth joint portion 30FP. The third supported metal member 5G3 is fixed to the lower surface of the left rear corner portion of the main body 3B of the base member 3, and is connected to the fourth joint portion 30DP. The fourth supported metal member 5G4 is fixed to the lower surface of the right front corner portion of the main body 3B of the base member 3, and is connected to the twelfth joint portion 30LP. In the illustrated example, the supported metal member 5G and the embedded member 30 are connected by welding. However, the supported metal member 5G and the embedded member 30 may be connected using a conductive adhesive material, solder, or the like.

The first movable joint portion 7MA of the first flexible metal member 7A is fixed to the lower surface of the right front corner portion of the main body 3B of the base member 3, and is connected to the eleventh joint portion 30KP. The second movable joint portion 7MB of the second flexible metal member 7B is fixed to the lower surface of the left rear corner portion of the main body 3B of the base member 3, and is connected to the fifth joint portion 30EP. In the illustrated example, the flexible metal member 7 and the embedded member 30 are connected by welding. However, the flexible metal member 7 and the embedded member 30 may be connected using a conductive adhesive material, solder, or the like.

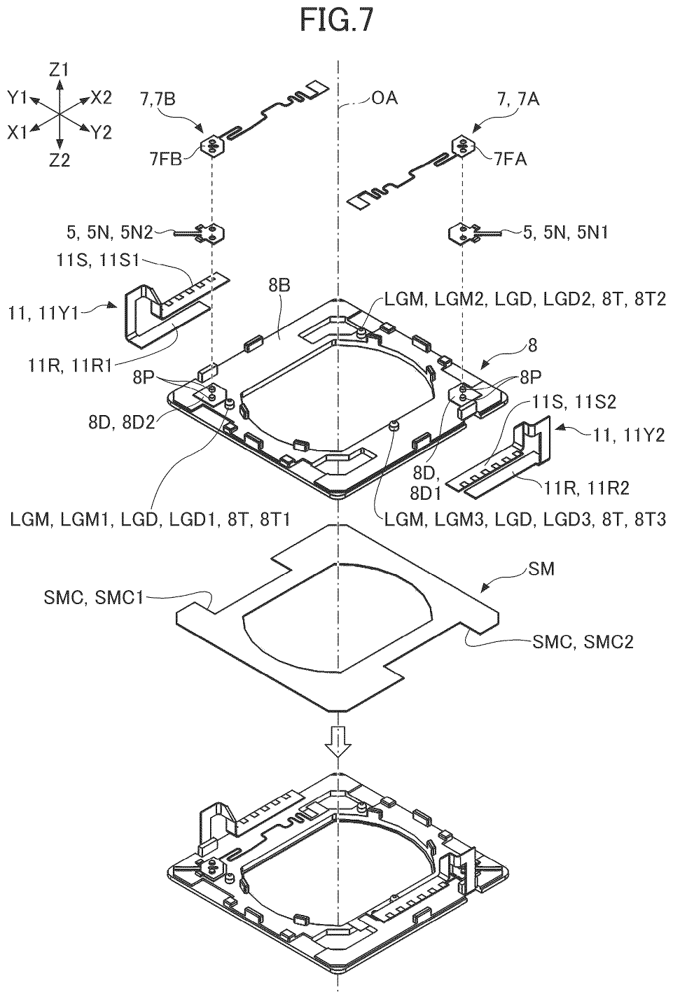

Next, a positional relationship between a member attached to the support member 8, and the support member 8 will be described with reference to FIG. 7. FIG. 7 is a perspective view of the support-side metal member 5N, the flexible metal member 7, the support member 8, the flexible wiring board 11, and the support-side magnetic member SM. Particularly, an upper portion of FIG. 7 above a downward pointing block arrow is a disassembled perspective view, and a lower portion of FIG. 7 below the downward pointing block arrow is an assembly perspective view.

The first fixed joint portion 7FA of the first flexible metal member 7A is fixed to the first pedestal portion 8D1 of the support member 8, together with the first support-side metal member 5N1. The second fixed joint portion 7FB of the second flexible metal member 7B is fixed to the second pedestal portion 8D2 of the support member 8, together with the second support-side metal member 5N2. Particularly, each of the first fixed joint portion 7FA and the first support-side metal member 5N1 is formed with a through hole through which a round projection 8P formed on the upper surface of the first pedestal portion 8D1 and projecting upward is inserted. Further, each of the second fixed joint portion 7FB and the second support-side metal member 5N2 is formed with a through hole through which the round projection 8P formed on the upper surface of the second pedestal portion 8D2 and projecting upward is inserted. In the illustrated example, the flexible metal member 7 and the support-side metal member 5N are connected to the projection 8P using an adhesive. However, the connection of the flexible metal member 7, the support-side metal member 5N, and the projection 8P may be achieved by performing a hot staking or a cold staking on the projection 8P. The first fixed joint portion 7FA has a through hole having a rounded rectangular shape, which is used for welding the first fixed joint portion 7FA and the first support-side metal member 5N1. That is, the first fixed joint portion 7FA and the first support-side metal member 5N1 are connected by welding. However, the first fixed joint portion 7FA and the first support-side metal member 5N1 may be connected using a conductive adhesive, solder, or the like. The same applies to the connection between the second fixed joint portion 7FB and the second support-side metal member 5N2.

As illustrated in FIG. 5, portions of the embedded member 30 (the third embedded member 30C, the fourth embedded member 30D, and the tenth embedded member 30J) have exposed portions (the third exposed portion 30CQ, the fourth exposed portion 30DQ, and the tenth exposed portion 30JQ) exposed at the lower surface of the base member 3, respectively. As illustrated in FIG. 7, the support member 8 has a plurality of contact portions 8T projecting upward from the base portion 8B and having tip ends thereof in contact with a lower guided part LGE which is a portion of the exposed portions of the embedded member 30. Each of the three contact portions 8T has a shape that is a combination of a cylinder and a hemisphere, and functions as a lower guiding part LGD, and the exposed portions of the embedded member 30 function as the lower guided part LGE. The lower guided part LGE and the lower guided part LGD constitute a lower guide mechanism LGM for guiding the movement of the base member 3 with respect to the support member 8 in the direction perpendicular to the optical axis QA.

In the illustrated example, the contact portion 8T includes a first contact portion 8T1 functioning as a first lower guide portion LGD1, a second contact portion 8T2 functioning as a second lower guide portion LGD2, and a third contact portion 8T3 functioning as a third lower guide portion LGD3. The exposed portions of the embedded member 30 include the third exposed portion 30CQ functioning as a first lower guided portion LGE1, the fourth exposed portion 30DQ functioning as a second lower guided portion LGE2, and the tenth exposed portion 30JQ functioning as a third lower guided portion LGE3. The first lower guide portion LGD1 and the first lower guided portion LGE1 constitute a first lower guide mechanism LGM1. The second lower guide portion LGD2 and the second lower guided portion LGE2 constitute a second lower guide mechanism LGM2. The third lower guide portion LGD3 and the third lower guided portion LGE3 constitute a third lower guide mechanism LGM3.

Particularly, the first lower guide portion LGD1 (first contact portion 8T1) is in contact with the lower surface of the first lower guided portion LGE1 which is a portion of the third exposed portion 30CQ of the third embedded member 30C. The second lower guide portion LGD2 (second contact portion 8T2) is in contact with the lower surface of the second lower guided portion LGE2 which is a portion of the fourth exposed portion 30DQ of the fourth embedded member 30D. The third lower guide portion LGD3 (third contact portion 8T3) is in contact with the lower surface of the third lower guided portion LGE3 which is a portion of the tenth exposed portion 30JQ of the tenth embedded member 30J.

This configuration provides an effect of enabling the embedded member 30 to be used as the lower guided part LGE when moving the base member 3 in the directions (the X-axis direction and the Y-axis direction) perpendicular to the optical axis direction. That is, this configuration provides an effect of enabling the embedded member 30, formed of a metal that is less prone to deformation compared to a synthetic resin, to be used as the lower guided part LGE. Further, the sliding between the metal (the embedded member 30) and the synthetic resin (the contact portion 8T) can prevent the synthetic resin from wear compared to a case where synthetic resins slide against each other. For this reason, this configuration provides an effect of reducing generation of wear debris. The number of the contact portions 8T may be four or more. That is, the number of the lower guide mechanisms LGM may be four or more.

As illustrated in FIG. 5, a recess 8R for accommodating one end 11R of the flexible wiring board 11 is formed in the lower surface of the support member 8. The support-side magnetic member SM is provided with a cutout SMC corresponding to the one end 11R of the flexible wiring board 11. The one end 11R of the flexible wiring board 11 is connected to a terminal portion (not illustrated) formed on the substrate SU, and the other end 11S of the flexible wiring board 11 is arranged on the upper surface of the base member 3 and connected to the terminal portion of the embedded member 30. Particularly, the recess 8R includes a first recess 8R1 for accommodating one end 11R1 of the first flexible wiring board 11Y1, and a second recess 8R2 for accommodating one end 11R2 of the second flexible wiring board 11Y2. The cutout SMC includes a first cutout SMC1 corresponding to the one end 11R1 of the first flexible wiring board 11Y1, and a second cutout SMC2 corresponding to the one end 11R2 of the second flexible wiring board 11Y2. The other end 11S1 of the first flexible wiring board 11Y1 is placed on the upper surface of the second side portion 3E2 of the base member 3, and is connected to the terminal portions (the first through sixth terminal portions 30AT through 30FT) of the first through sixth embedded members 30A through 30F, respectively. The other end 11S2 of the second flexible wiring board 11Y2 is placed on the upper surface of the fourth side portion 3E4 of the base member 3, and is connected to the terminal portions (the seventh through twelfth terminal portions 30GT through 30LT) of the seventh through twelfth embedded members 30G through 30L, respectively.

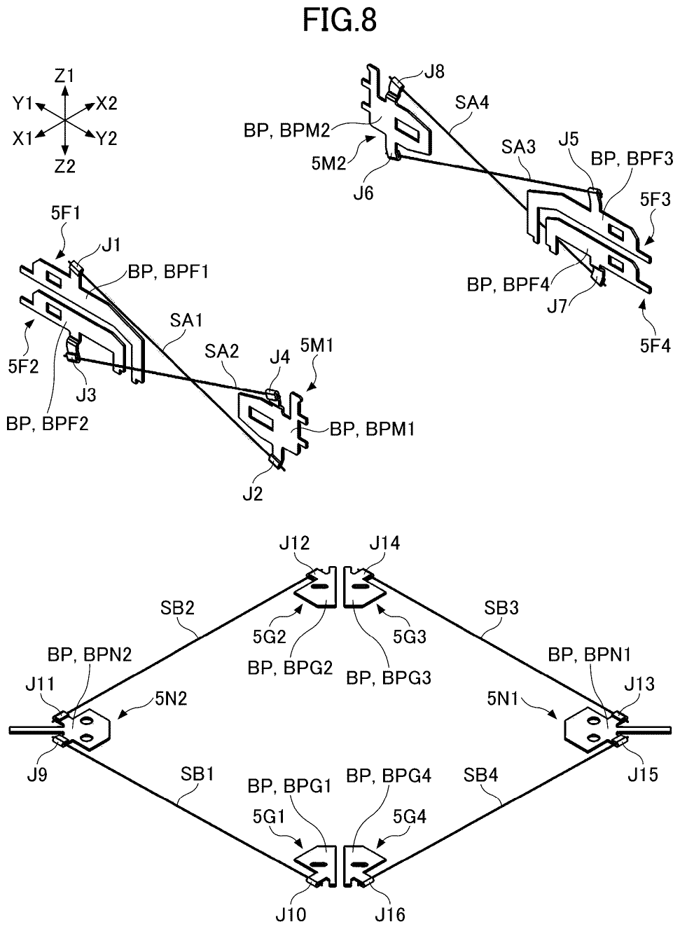

Next, the metal member 5 to which the shape memory alloy wire is attached will be described with reference to FIG. 8. FIG. 8 is a diagram illustrating configuration examples of the metal member 5 and the shape memory alloy wire. Particularly, an upper portion of FIG. 8 is a perspective view of the first through fourth base-side metal members 5F1 through 5F4, the first lens-side metal member 5M1, the second lens-side metal member 5M2, and the first through fourth wires SA1 through SA4. A lower portion of FIG. 8 is a perspective view of the first through fourth supported metal members 5G1 through 5G4, the first support-side metal member 5N1, the second support-side metal member 5N2, and the first through fourth wires SB1 through SB4. A positional relationship of the members illustrated in FIG. 8 corresponds to the positional relationship when the lens driving device 101 is in the neutral state.

Particularly, one end of the first wire SA1 is fixed to the first base-side metal member 5F1 at a holding portion J1 of the first base-side metal member 5F1, and the other end of the first wire SA1 is fixed to the first lens-side metal member 5M1 at a holding portion J2 of the first lens-side metal member 5M1. Similarly, one end of the second wire SA2 is fixed to the second base-side metal member 5F2 at a holding portion J3 of the second base-side metal member 5F2, and the other end of the second wire SA2 is fixed to the first lens-side metal member 5M1 at a holding portion J4 of the first lens-side metal member 5M1.

In addition, one end of the third wire SA3 is fixed to the third base-side metal member 5F3 at a holding portion J5 of the third base-side metal member 5F3, and the other end of the third wire SA3 is fixed to the second lens-side metal member 5M2 at a holding portion J6 of the second lens-side metal member 5M2. Similarly, one end of the fourth wire SA4 is fixed to the fourth base-side metal member 5F4 at a holding portion J7 of the fourth base-side metal member 5F4, and the other end of the fourth wire SA4 is fixed to the second lens-side metal member 5M2 at a holding portion J8 of the second lens-side metal member 5M2.

Moreover, one end of the first wire SB1 is fixed to the second support-side metal member 5N2 at a holding portion J9 of the second support-side metal member 5N2, and the other end of the first wire SB1 is fixed to the first supported metal member 5G1 at a holding portion J10 of the first supported metal member 5G1. Similarly, one end of the second wire SB2 is fixed to the second support-side metal member 5N2 at a holding portion J11 of the second support-side metal member 5N2, and the other end of the second wire SB2 is fixed to the second supported metal member 5G2 at a holding portion J12 of the second supported metal member 5G2.

Further, one end of the third wire SB3 is fixed to the first support-side metal member 5N1 at a holding portion J13 of the first support-side metal member 5N1, and the other end of the third wire SB3 is fixed to the third supported metal member 5G3 at a holding portion J14 of the third supported metal member 5G3. Similarly, one end of the fourth wire SB4 is fixed to the first support-side metal member 5N1 at a holding portion J15 of the first support-side metal member 5N1, and the other end of the fourth wire SB4 is fixed to the fourth supported metal member 5G4 at a holding portion J16 of the fourth supported metal member 5G4.

The holding portion J1 is formed by bending a portion of the first base-side metal member 5F1. Particularly, a portion of the first base-side metal member 5F1 is bent in a state pinching one end of the first wire SA1, thereby forming the holding portion J1. One end of the first wire SA1 is fixed to the holding portion J1 by welding. The same applies to the holding portions J2 through J16.

The base member 3 is configured to function as a wire support member that supports one end of each of the first through fourth wires SA1 through SA4. According to this configuration, the lens holding member 2 on which the other ends of the first through fourth wires SA1 through SA4 are located, is connected to the base member 3 via the first through fourth wires SA1 through SA4 in a state where the lens holding member 2 is movable in the optical axis direction (the Z-axis direction) which is a direction parallel to the optical axis QA.

The support member 8 is configured to function as a wire support member that supports one end of each of the first through fourth wires SB1 through SB4. According to this configuration, the base member 3 on which the other ends of the first through fourth wires SB1 through SB4 are located, is connected to the support member 8 via the first through fourth wires SB1 through SB4 in a state where the base member 3 is movable in the directions (the X-axis direction and the Y-axis direction) perpendicular to the optical axis QA.

In the illustrated example, each of the base-side metal member 5F and the lens-side metal member 5M is formed of a metal plate having the plate-shaped base BP. Particularly, the first base-side metal member 5F1 has the base portion BPF1, the second base-side metal member 5F2 has the base portion BPF2, the third base-side metal member 5F3 has the base portion BPF3, and the fourth base-side metal member 5F4 has the base portion BPF4. The first lens-side metal member 5M1 has the base portion BPM1, and the second lens-side metal member 5M2 has the base portion BPM2. As illustrated in the upper portion of FIG. 8, the first base-side metal member 5F1, the second base-side metal member 5F2, the third base-side metal member 5F3, the fourth base-side metal member 5F4, the first lens-side metal member 5M1, and the second lens-side metal member 5M2 are attached to the base member 3 or the lens holding member 2, so that plate surfaces of the base portions BPF1, BPF2, BPF3, BPF4, BPM1, and BPM2 are parallel to the YZ-plane, that is, approximately parallel to one another. The first base-side metal member 5F1, the second base-side metal member 5F2, and the first lens-side metal member 5M1 are attached to the base member 3 or the lens holding member 2, so that the plate surfaces of the base portions BPF1, BPF2, and BPM1 are located on approximately the same plane. Similarly, the third base-side metal member 5F3, the fourth base-side metal member 5F4, and the second lens-side metal member 5M2 are attached to the base member 3 or the lens holding member 2, so that the plate surfaces of the base portions BPF3, BPF4, and BPM2 are located on approximately the same plane.

In the illustrated example, each of the supported metal member 5G and the support-side metal member 5N is formed of a metal plate having the plate-shaped base BP. Particularly, the first supported metal member 5G1 has a base portion BPG1, the second supported metal member 5G2 has a base portion BPG2, the third supported metal member 5G3 has a base portion BPG3, the fourth supported metal member 5G4 has a base portion BPG4, the first support-side metal member 5N1 has a base portion BPN1, and the second support-side metal member 5N2 has a base portion BPN2. As illustrated in the lower portion of FIG. 8, the first supported metal member 5G1, the second supported metal member 5G2, the third supported metal member 5G3, the fourth supported metal member 5G4, the first support-side metal member 5N1, and the second support-side metal member 5N2 are attached to the base member 3 or the support member 8, so that the plate surfaces of the base portions BPG1, BPG2, BPG3, BPG4, BPN1, and BPN2 are parallel to the XY-plane, that is, approximately parallel to one another. The first supported metal member 5G1, the second supported metal member 5G2, the third supported metal member 5G3, and the fourth supported metal member 5G4 are attached to the base member 3, so that the plate surfaces of the base portions BPG1, BPG2, BPG3, and BPG4 are located on approximately the same plane. Similarly, the first support-side metal member 5N1 and the second support-side metal member 5N2 are attached to the support member 8, so that the plate surfaces of the base portions BPN1 and BPN2 are located on approximately the same plane.

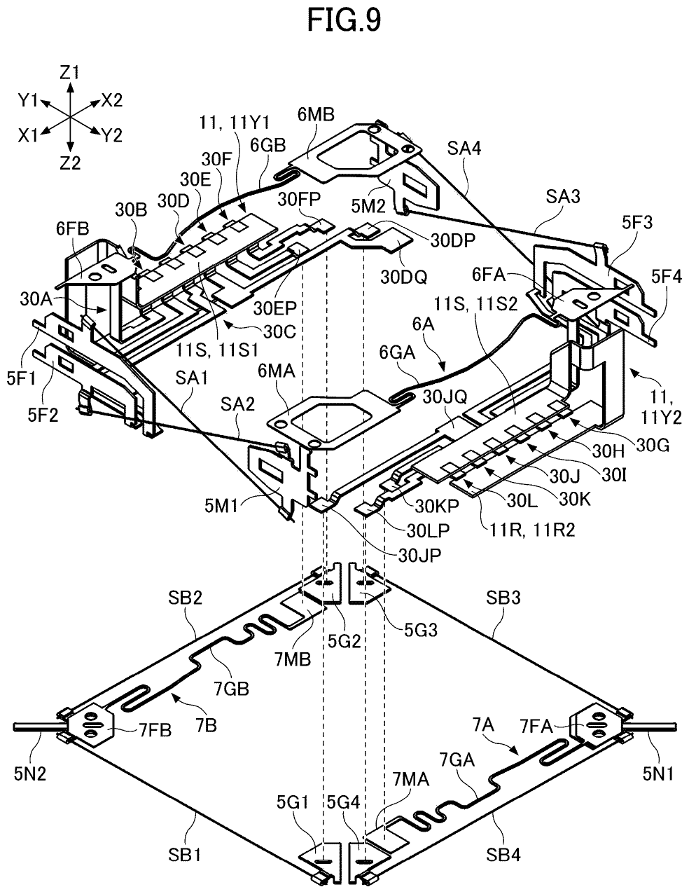

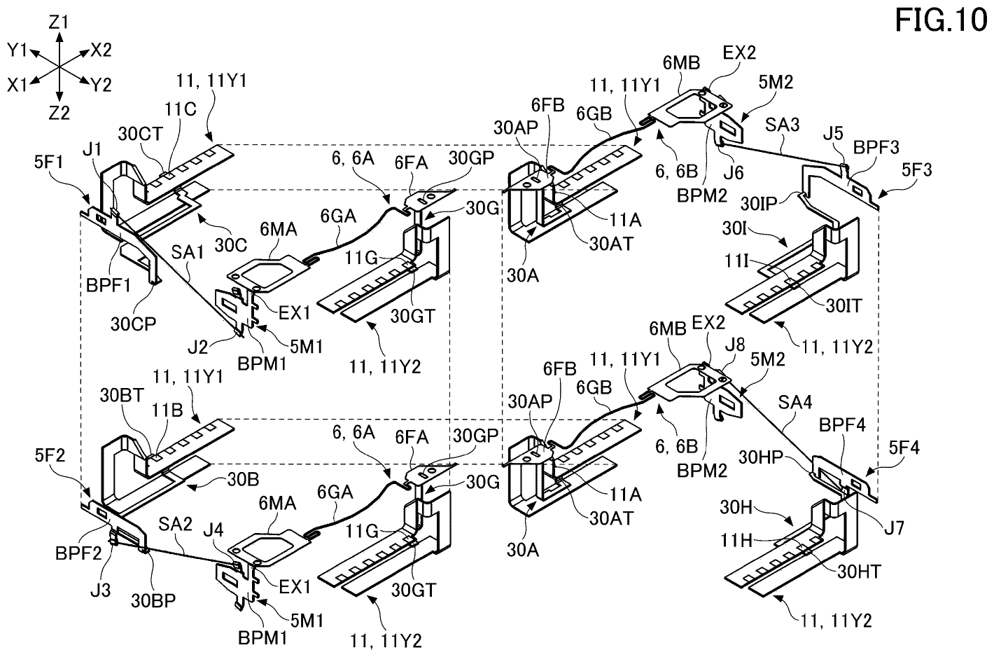

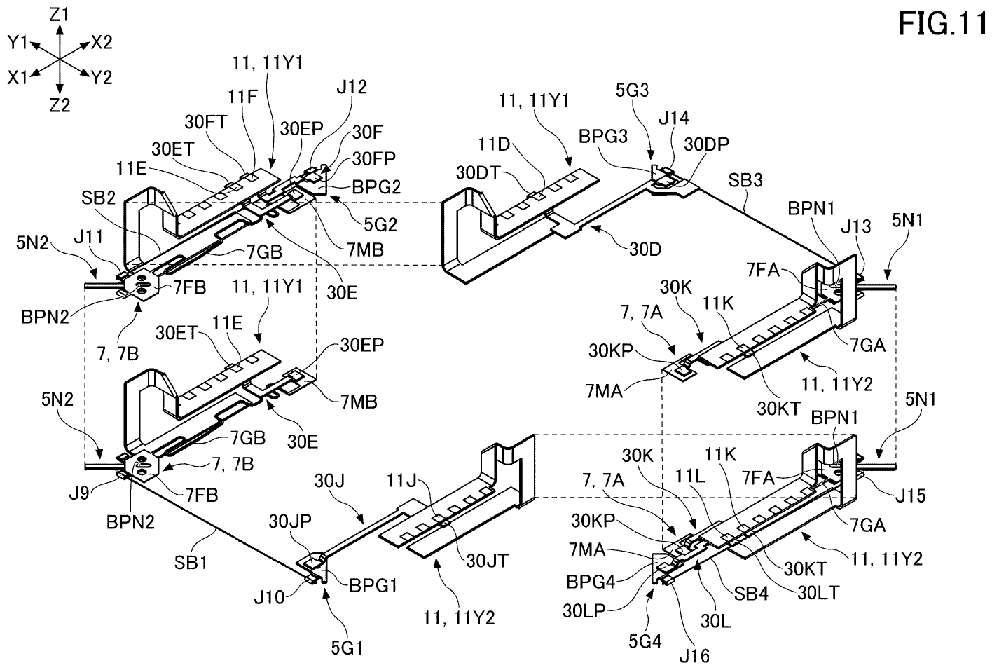

Next, positional relationships of the metal member 5, the leaf spring 6, the flexible metal member 7, the flexible wiring board 11, the embedded member 30, the shape memory alloy wire SA, and the shape memory alloy wire SB, which are members through which a current flows, will be described with reference to FIG. 9, FIG. 10, and FIG. 11. FIG. 9 is a perspective view of the metal member 5, the leaf spring 6, the flexible metal member 7, the flexible wiring board 11, the embedded member 30, the shape memory alloy wire SA, and the shape memory alloy wire SB. More particularly, an upper portion of FIG. 9 is a perspective view of the members related to the current path including the shape memory alloy wire SA, and a lower portion of FIG. 9 is a perspective view of the members related to the current path including the shape memory alloy wire SB. FIG. 10 illustrates extracted portions of FIG. 9. An upper left portion of FIG. 10 illustrates the members related to a conductive path including the first wire SA1, a lower left portion of FIG. 10 illustrates the members related to a conductive path including the second wire SA2, an upper right portion of FIG. 10 illustrates the members related to a conductive path including the third wire SA3, and a lower right portion of FIG. 10 illustrates the members related to a conductive path including the fourth wire SA4. Further, FIG. 11 illustrates extracted portions of FIG. 9. A lower left portion of FIG. 11 illustrates the members related to a conductive path including the first wire SB1, an upper left portion of FIG. 11 illustrates the members related to a conductive path including the second wire SB2, an upper right portion of FIG. 11 illustrates the members related to a conductive path including the third wire SB3, and a lower right portion of FIG. 11 illustrates the members related to a conductive path including the fourth wire SB4.

As illustrated in the upper left portion of FIG. 10, when the third terminal portion 11C of the first flexible wiring board 11Y1 is connected to a high potential and the seventh terminal portion 11G of the second flexible wiring board 11Y2 is connected to a low potential, the current flows from the third terminal portion 11C of the first flexible wiring board 11Y1 to the seventh terminal portion 11G of the second flexible wiring board 11Y2 via the third terminal portion 30CT of the third embedded member 30C, the third joint portion 30CP, the first base-side metal member 5F1 (the base portion BPF1 and the holding portion J1), the first wire SA1, the first lens-side metal member 5M1 (the holding portion J2, the base portion BPM1, and a first extending portion EX1), the first leaf spring 6A (the first lens-side joint portion 6MA, the first elastic arm portion 6GA, and the first base-side joint portion 6FA), and the seventh embedded member 30G (the seventh joint portion 30GP and the seventh terminal portion 30GT).

As illustrated in the lower left portion of FIG. 10, when the second terminal portion 11B of the first flexible wiring board 11Y1 is connected to a high potential and the seventh terminal portion 11G of the second flexible wiring board 11Y2 is connected to a low potential, the current flows from the second terminal portion 11B of the first flexible wiring board 11Y1 to the seventh terminal portion 11G of the second flexible wiring board 11Y2 via the second terminal portion 30BT of the second embedded member 30B, the second joint portion 30BP, the second base-side metal member 5F2 (the base portion BPF2 and the holding portion J3), the second wire SA2, the first lens-side metal member 5M1 (the holding portion J4, the base portion BPM1, and the first extending portion EX1), the first leaf spring 6A (the first lens-side joint portion 6MA, the first elastic arm portion 6GA, and the first base-side joint portion 6FA), and the seventh embedded member 30G (the seventh joint portion 30GP and the seventh terminal portion 30GT).

In either case where the third terminal portion 11C of the first flexible wiring board 11Y1 is connected to the high potential or where the second terminal portion 11B of the first flexible wiring board 11Y1 is connected to the high potential, the path of the current flowing from the first lens-side metal member 5M1 to the seventh terminal portion 11G of the second flexible wiring board 11Y2 is the same.

In addition, as illustrated in the upper right portion of FIG. 10, when the ninth terminal portion 11I of the second flexible wiring board 11Y2 is connected to a high potential and the first terminal portion 11A of the first flexible wiring board 11Y1 is connected to a low potential, the current flows from the ninth terminal portion 11I of the second flexible wiring board 11Y2 to the first terminal portion 11A of the first flexible wiring board 11Y1 via the ninth terminal portion 30IT of the ninth embedded member 30I, the ninth joint portion 30IP, the third base-side metal member 5F3 (the base portion BPF3 and the holding portion J5), the third wire SA3, the second lens-side metal member 5M2 (the holding portion J6, the base portion BPM2, and the second extending portion EX2), the second leaf spring 6B (the second lens-side joint portion 6MB, the second elastic arm portion 6GB, and the second base-side joint portion 6FB), and the first embedded member 30A (the first joint portion 30AP and the first terminal portion 30AT).

Further, as illustrated in the lower right portion of FIG. 10, when the eighth terminal portion 11H of the second flexible wiring board 11Y2 is connected to a high potential and the first terminal portion 11A of the first flexible wiring board 11Y1 is connected to a low potential, the current flows from the eighth terminal portion 11H of the second flexible wiring board 11Y2 to the first terminal portion 11A of the first flexible wiring board 11Y1 via the eighth terminal portion 30HT of the eighth embedded member 30H, the eighth joint portion 30HP, the fourth base-side metal member 5F4 (the base portion BPF4 and the holding portion J7), the fourth wire SA4, the second lens-side metal member 5M2 (the holding portion J8, the base portion BPM2, and the second extending portion EX2), the second leaf spring 6B (the second lens-side joint portion 6MB, the second elastic arm portion 6GB, and the second base-side joint portion 6FB), and the first embedded member 30A (the first joint portion 30AP and the first terminal portion 30AT).

In either case where the ninth terminal portion 11I of the second flexible wiring board 11Y2 is connected to the high potential or where the eighth terminal portion 11H of the second flexible wiring board 11Y2 is connected to the high potential, the path of the current flowing from the second lens-side metal member 5M2 to the first terminal portion 11A of the first flexible wiring board 11Y1 is the same.

Moreover, as illustrated in the lower left portion of FIG. 11, when the tenth terminal portion 11J of the second flexible wiring board 11Y2 is connected to a high potential and the fifth terminal portion 11E of the first flexible wiring board 11Y1 is connected to a low potential, the current flows from the tenth terminal portion 11J of the second flexible wiring board 11Y2 to the fifth terminal portion 11E of the first flexible wiring board 11Y1 via the tenth terminal portion 30JT of the tenth embedded member 30J, the tenth joint portion 30JP, the first supported metal member 5G1 (the base portion BPG1 and the holding portion J10), the first wire SB1, the second support-side metal member 5N2 (the holding portion J9 and the base portion BPN2), the second flexible metal member 7B (the second fixed joint portion 7FB, the second elastic arm portion 7GB, and the second movable joint portion 7MB), and the fifth embedded member 30E (the fifth joint portion 30EP and the fifth terminal portion 30ET).

Further, as illustrated in the upper left portion of FIG. 11, when the sixth terminal portion 11F of the first flexible wiring board 11Y1 is connected to a high potential and the fifth terminal portion 11E of the first flexible wiring board 11Y1 is connected to a low potential, the current flows from the sixth terminal portion 11F of the first flexible wiring board 11Y1 to the fifth terminal portion 11E of the first flexible wiring board 11Y1 via the sixth terminal portion 30FT of the sixth embedded member 30F, the sixth joint portion 30FP, the second supported metal member 5G2 (the base portion BPG2 and the holding portion J12), the second wire SB2, the second support-side metal member 5N2 (the holding portion J11 and the base portion BPN2), the second flexible metal member 7B (the second fixed joint portion 7FB, the second elastic arm portion 7GB, and the second movable joint portion 7MB), and the fifth embedded member 30E (the fifth joint portion 30EP and the fifth terminal portion 30ET).

In either the case where the tenth terminal portion 11J of the second flexible wiring board 11Y2 is connected to a high potential or where the sixth terminal portion 11F of the first flexible wiring board 11Y1 is connected to a high potential, the path of the current flowing from the second support-side metal member 5N2 to the fifth terminal portion 11E of the first flexible wiring board 11Y1 is the same.

As illustrated in the upper right portion of FIG. 11, when the fourth terminal portion 11D of the first flexible wiring board 11Y1 is connected to a high potential and the eleventh terminal portion 11K of the second flexible wiring board 11Y2 is connected to a low potential, the current flows from the fourth terminal portion 11D of the first flexible wiring board 11Y1 to the eleventh terminal portion 11K of the second flexible wiring board 11Y2 via the fourth terminal portion 30DT of the fourth embedded member 30D, the fourth joint portion 30DP, the third supported metal member 5G3 (the base portion BPG3 and the holding portion J14), the third wire SB3, the first support-side metal member 5N1 (the holding portion J13 and the base portion BPN1), the first flexible metal member 7A (the first fixed joint portion 7FA, the first elastic arm portion 7GA, and the first movable joint portion 7MA), and the eleventh embedded member 30K (the eleventh joint portion 30KP and the eleventh terminal portion 30KT).

Further, as illustrated in the lower right portion of FIG. 11, when the twelfth terminal portion 11L of the second flexible wiring board 11Y2 is connected to a high potential and the eleventh terminal portion 11K of the second flexible wiring board 11Y2 is connected to a low potential, the current flows from the twelfth terminal portion 11L of the second flexible wiring board 11Y2 to the eleventh terminal portion 11K of the second flexible wiring board 11Y2 via the twelfth terminal portion 30LT of the twelfth embedded member 30L, the twelfth joint portion 30LP, the fourth supported metal member 5G4 (the base portion BPG4 and the holding portion J16), the fourth wire SB4, the first support-side metal member 5N1 (the holding portion J15 and the base portion BPN1), the first flexible metal member 7A (the first fixed joint portion 7FA, the first elastic arm portion 7GA, and the first movable joint portion 7MA), and the eleventh embedded member 30K (the eleventh joint portion 30KP and the eleventh terminal portion 30KT).

In either case where the fourth terminal portion 11D of the first flexible wiring board 11Y1 is connected to the high potential or where the twelfth terminal portion 11L of the second flexible wiring board 11Y2 is connected to the high potential, the path of the current flowing from the first support-side metal member 5N1 to the eleventh terminal portion 11K of the second flexible wiring board 11Y2 is the same.

The control device outside the lens driving device 101 described above can control the lengths of the shape memory alloy wire SA (the first through fourth wires SA1 through SA4) and the shape memory alloy wire SB (the first through fourth wires SB1 through SB4) by controlling the voltages applied to the terminal portions (the first through twelfth terminal portions 11A through 11L) of the first flexible wiring board 11Y1 and the second flexible wiring board 11Y2, for example. The control device may detect the electric resistance value of each of the shape memory alloy wires and control the length of each of the shape memory alloy wires according to the detection result, for example. The control device may be arranged inside the lens driving device 101. The control device may be a constituent element or a component of the lens driving device 101.

The control device may move the lens holding member 2 along a direction (the Z-axis direction) parallel to the optical axis QA on the Z1-side (the subject side) of the image sensor IS, utilizing a driving force along a direction parallel to the optical axis QA due to contraction of the shape memory alloy wire SA as the first driving portion DM1. By moving the lens holding member 2 in this manner, the control device may achieve an automatic focus adjustment function which is one of lens adjustment functions. Particularly, the control device may move the lens holding member 2 in a direction away from the image sensor IS to enable macro shooting, and may move the lens holding member 2 in a direction toward the image sensor IS to enable infinity shooting.

In addition, the control device may control the current flowing through the shape memory alloy wire SB as the second driving portion DM2 to move the lens holding member 2 in a direction (each of the X-axis direction and the Y-axis direction) intersecting the optical axis QA. Thus, the control device may achieve an image stabilization function (a shake correction function).

Next, a relationship of the force acting on the lens holding member 2 in the directions (the X-axis direction and the Y-axis direction) intersecting the optical axis QA will be described, by referring again to FIG. 6.

When a current flows through at least one of the first wire SA1 and the second wire SA2 and the wire contracts, the lens holding member 2 (the first pedestal portion 2D1) is pulled leftward (Y1-direction), and the first guided portion GE1 (the groove portion 2V) is pressed against the first receiving member 9A by a leftward pressing force PF (a first pressing force PF1).

On the other hand, because a magnetic force MF (a first magnetic force MF1 as an attractive force) acts between the first lens-side magnetic member 14 fixed to the lens holding member 2 and the first base-side magnetic member BM1 fixed to the base member 3, the first guided portion GE1 (the groove portion 2V) is pulled to the right (the Y2-direction) by the rightward magnetic force MF (the first magnetic force MF1).

For this reason, at least a portion of the leftward pressing force PF (the first pressing force PF1) and a portion of the rightward magnetic force MF (the first magnetic force MF1) cancel each other, and the pressing force PF (the first pressing force PF1) is suppressed. As a result, the first guided portion GE1 (the groove portion 2V) is moved in the optical axis direction by a relatively small force in the optical axis direction (a component in the optical axis direction of the force of at least one of the first wire SA1 and the second wire SA2) when compared to a case where the magnetic force MF (the first magnetic force MF1) does not act.

Similarly, when a current flows through at least one of the third wire SA3 and the fourth wire SA4 and the wire contracts, the lens holding member 2 (the second pedestal portion 2D2) is pulled rightward (the Y2-direction), and the second guided portion GE2 (the flat portion 2F) is pressed against the second receiving member 9B by a rightward pressing force PF (a second pressing force PF2).

On the other hand, because the magnetic force MF (a second magnetic force MF2 as an attractive force) acts between the second lens-side magnetic member LM2 fixed to the lens holding member 2 and the second base-side magnetic member BM2 fixed to the base member 3, the second guided portion GE2 (the flat portion 2F) is pulled leftward (the Y1-direction) by a leftward magnetic force MF (the second magnetic force MF2).

For this reason, at least a portion of the rightward pressing force PF (the second pressing force PF2) and a portion of the leftward magnetic force MF (the second magnetic force MF2) cancel each other, and the pressing force PF (the second pressing force PF2) is suppressed. As a result, the second guided portion GE2 (the flat portion 2F) is moved in the optical axis direction by a relatively small force in the optical axis direction (a component in the optical axis direction of the force by at least one of the third wire SA3 and the fourth wire SA4) compared to a case where the magnetic force MF (the second magnetic force MF2) does not act.

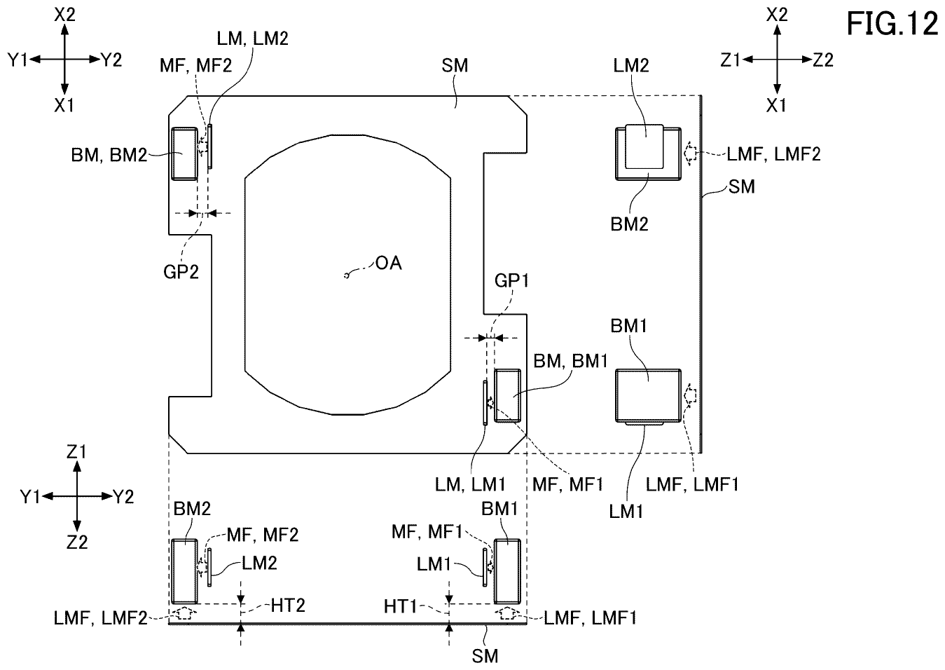

Next, a positional relationship of the base-side magnetic member BM, the lens-side magnetic member LM, and the support-side magnetic member SM will be described, with reference to FIG. 12. FIG. 12 is a three-side view (a front view, a top view, and a right side view) of the base-side magnetic member BM, the lens-side magnetic member LM, and the support-side magnetic member SM. The positional relationship of the members illustrated in FIG. 12 corresponds to the positional relationship when the lens driving device 101 is in the neutral state.

Particularly, the first base-side magnetic member BM1 and the first lens-side magnetic member LM1 are arranged to oppose each other with a gap GP1 in the Y-axis direction. In addition, the second base-side magnetic member BM2 and the second lens-side magnetic member LM2 are arranged to oppose each other with a gap GP2 in the Y-axis direction. In the illustrated example, the gap GP1 and the gap GP2 have the same size.

This arrangement provides an effect of preventing the lens holding member 2 (the lens-side magnetic member LM) and the base member 3 (the base-side magnetic member BM) from separating from each other, by utilizing the magnetic force acting between the base-side magnetic member BM and the lens-side magnetic member LM.

The first base-side magnetic member BM1 and the support-side magnetic member SM are arranged to oppose each other with a gap HT1 in the Z-axis direction. In addition, the second base-side magnetic member BM2 and the support-side magnetic member SM are arranged to oppose each other with a gap HT2 in the Z-axis direction. In the illustrated example, the gap HT1 and the gap HT2 have the same size.

This arrangement provides an effect of preventing the base member 3 (the base-side magnetic member BM) and the support member 8 (the support-side magnetic member SM) from separating from each other, by utilizing the magnetic force acting between the base-side magnetic member BM and the support-side magnetic member SM.

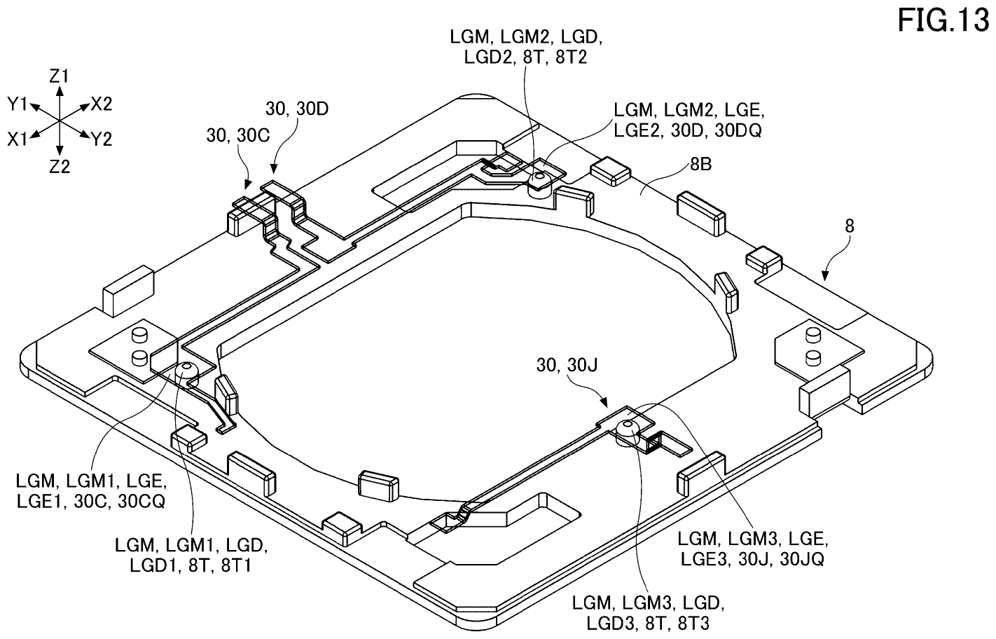

Next, the lower guide mechanism LGM will be described in detail, with reference to FIG. 13. FIG. 13 is a perspective view of the support member 8, the third embedded member 30C, the fourth embedded member 30D, and the tenth embedded member 30J. In FIG. 13, the third embedded member 30C, the fourth embedded member 30D, and the tenth embedded member 30J are illustrated to appear transparent for the sake of convenience and clarity. The positional relationship of the members illustrated in FIG. 13 corresponds to the positional relationship when the lens driving device 101 is in the neutral state.

The lower guide mechanism LGM is configured to guide the movement of the base member 3 with respect to the support member 8 in the directions perpendicular to the optical axis OA (the X-axis direction and the Y-axis direction). Particularly, the lower guide mechanism LGM includes the lower guiding part LGD and the lower guided part LGE. In addition, the lower guide mechanism LGM includes the first lower guide mechanism LGM1, the second lower guide mechanism LGM2, and the third lower guide mechanism LGM3.

Particularly, the first lower guide mechanism LGM1 includes the first lower guide portion LGD1 and the first lower guided portion LGE1, the second lower guide mechanism LGM2 includes the second lower guide portion LGD2 and the second lower guided portion LGE2, and the third lower guide mechanism LGM3 includes the third lower guide portion LGD3 and the third lower guided portion LGE3.

In the illustrated example, the first lower guide portion LGD1, the second lower guide portion LGD2, and the third lower guide portion LGD3 are the first contact portion 8T1, the second contact portion 8T2, and the third contact portion 8T3 provided on the upper surface of the base portion 8B of the support member 8, respectively. The first lower guided portion LGE1 is the third exposed portion 30CQ of the third embedded member 30C, the second lower guided portion LGE2 is the fourth exposed portion 30DQ of the fourth embedded member 30D, and the third lower guided portion LGE3 is the tenth exposed portion 30JQ of the tenth embedded member 30J. The first contact portion 8T1, the second contact portion 8T2, and the third contact portion 8T3 have the same height with respect to the upper surface of the base portion 8B.

The lower guide mechanism LGM provides an effect of smoothly guiding the base member 3 to move with respect to the support member 8 in the directions perpendicular to the optical axis OA (the X-axis direction and the Y-axis direction). That is, the lower guide mechanism LGM provides an effect of enabling the embedded member 30, formed of a metal that is less prone to deformation compared to a synthetic resin, to be used as the lower guided part LGE. Further, the sliding between the metal (the embedded member 30) and the synthetic resin (the contact portion 8T) can prevent the synthetic resin from wear compared to a case where synthetic resins slide against each other. For this reason, the configuration of the lower guide mechanism LGM provides an effect of reducing generation of wear debris.

As described above, the lens driving device 101 according to the embodiment of the present disclosure includes the base member 3, the lens holding member 2 having the tubular part 2C capable of holding the lens system LS and movable in the optical axis direction with respect to the base member 3, and the plurality of shape memory alloy wires SA (the first driving portion DM1) provided between the base member 3 and the lens holding member 2 and configured to move the lens holding member 2 in the optical axis direction, as illustrated in FIG. 2. The shape memory alloy wire SA has one end supported by the base member 3 and the other end supported by the lens holding member 2, at different positions in the optical axis direction. In the illustrated example, one end of the first wire SA1 is arranged at a position higher than the other end of the first wire SA1, and one end of the second wire SA2 is arranged at a position lower than the other end of the second wire SA2. One end of the third wire SA3 is arranged at a position higher than the other end of the third wire SA3, and one end of the fourth wire SA4 is arranged at a position lower than the other end of the fourth wire SA4. The base member 3 has the guiding part GD configured to guide the movement of the lens holding member 2 in the optical axis direction, and the lens holding member 2 has the guided part GE guided by the guide portion GD. The lens driving device 101 is configured so that, when a current is applied to the shape memory alloy wire SA, the pressing force PF (refer to FIG. 6), which causes the guiding part GD and the guided part GE to press against each other due to the contraction of the shape memory alloy wire SA, acts on the guiding part GD and the guided part GE, and the guided part GE slides along the guiding part GD.

This configuration provides an effect of stabilizing the movement of the lens holding member 2 in the optical axis direction when the lens holding member 2 moves in the optical axis direction, because the guided part GE slides on the surface of the guiding part GD in a state where the guided part GE is pressed against the guiding part GD. That is, this configuration provides an effect of preventing the lens holding member 2 from tilting when the lens holding member 2 moves in the optical axis direction.

Preferably, the base member 3 is provided with the base-side magnetic member BM, and the lens holding member 2 is provided with the lens-side magnetic member LM. Further, at least one of the base-side magnetic member BM and the lens-side magnetic member LM is formed of a magnet, and the magnetic force MF acts between the base-side magnetic member BM and the lens-side magnetic member LM so as to reduce the pressing force PF when the current flows through the shape memory alloy wire SA, as illustrated in FIG. 6.

This configuration provides an effect of weakening a frictional force between the guiding part GD and the guided part GE by the magnetic force MF, even in a case where a contraction force of the energized shape memory alloy wire SA becomes large and the pressing force PF becomes large.

Preferably, the base member 3 has the base-side metal member 5F to which one end of the shape memory alloy wire SA is fixed, and the lens holding member 2 has the lens-side metal member 5M to which the other end of the shape memory alloy wire SA is fixed, as illustrated in FIG. 2. The guiding part GD and the guided part GE are arranged at positions closer to the lens-side metal member 5M than to the base-side metal member 5F.

In this configuration, the guiding part GD and the guided part GE are arranged at the positions closer to the lens-side metal member 5M that moves in the optical axis direction than to the base-side metal member 5F that does not move in the optical axis direction. Thus, it is possible to obtain an effect of stabilizing the movement of the lens holding member 2 in the optical axis direction.

Preferably, the lens-side metal member 5M is formed of a metal plate having the plate-shaped base BP, as illustrated in FIG. 3. The lens holding member 2 has the attachment wall MW to which the lens-side metal member 5M is attached, and the guided wall GW formed along the plane (the XZ-plane) intersecting (approximately perpendicular to) the plane (the YZ-plane) along the plate surface of the base BP of the lens-side metal member 5M. The guided part GE is formed on an inner surface of the guided wall GW, and the lens-side magnetic member LM is fixed to an outer surface of the guided wall GW. As illustrated in FIG. 2, the base member 3 has the outer wall 3W arranged outside the guided wall GW, and the base-side magnetic member BM is fixed to the outer wall 3W. Further, the base-side magnetic member BM is formed of a magnet.

This configuration provides an effect of enabling the base-side magnetic member BM and the lens-side magnetic member LM to be arranged near the guiding part GD and the guided part GE, and reducing a distance between the base-side magnetic member BM and the lens-side magnetic member LM. For this reason, this configuration can efficiently increase the magnetic force MF acting between the base-side magnetic member BM and the lens-side magnetic member LM, and provide an effect of efficiently reducing the frictional force between the guiding part GD and the guided part GE.

Preferably, as illustrated in FIG. 3, a penetration part (a through hole) TH, penetrating a space surrounded by the annular pedestal 2D including the attachment wall MW and the guided wall GW in the optical axis direction, is formed at an outer side of the tubular part 2C. As illustrated in FIG. 2, the base member 3 has the projection 3T inserted through the penetration part TH, and the guiding part GD is provided on the projection 3T. In the illustrated example, the U-shaped groove 3V for receiving the approximately cylindrical receiving member 9 is formed in the projection 3T, as illustrated in FIG. 6. Particularly, the penetration part TH includes a first penetration portion TH1 through which the first projecting portion 3T1 is inserted, and a second penetration portion TH2 through which the second projecting portion 3T2 is inserted.

This configuration provides an effect of increasing a strength of the guiding part GD and making the guiding part GD less susceptible to deformation. Further, this configuration provides an effect of enabling the guided part GE to be made less susceptible to deformation by making the guiding part GD less susceptible to deformation.

Preferably, the guide mechanism GM composed of the combination of the guiding part GD and the guided part GE is provided in pairs, with the optical axis QA interposed between the pair of guiding part GD and the guided part GE, as illustrated in FIG. 6. Each of the pair of guide mechanisms GM (the first guide mechanism GM1 and the second guide mechanism GM2) is provided with the plurality of shape memory alloy wires SA corresponding to the guide mechanism GM. In the illustrated example, the first guide mechanism GM1 is provided with the first wire SA1 and the second wire SA2 corresponding to the first guide mechanism GM1, and the second guide mechanism GM2 is provided with the third wire SA3 and the fourth wire SA4 corresponding to the second guide mechanism GM2.

This configuration provides an effect of stabilizing the movement of the lens holding member 2 in the optical axis direction compared to a configuration in which only a single guide mechanism GM (a combination of the guiding part GD and the guided part GE) is provided.

Preferably, as illustrated in FIG. 2, the base member 3 has the plate-shaped main body 3B, and the lens holding member 2 is arranged on one side (the Z1-side) of the main body 3B, and the support member 8 is arranged on the other side (the Z2-side) of the main body 3B. The main body 3B of the base member 3 is movable in a direction perpendicular to the optical axis direction with respect to the support member 8, and the other shape memory alloy wire SB (the second driving portion DM2) for moving the base member 3 in a direction perpendicular to the optical axis direction is provided between the base member 3 and the support member 8.

This configuration provides an effect of achieving the shake correction function in addition to the automatic focus adjustment function.

Preferably, the main body 3B of the base member 3 is configured to be movable in the directions (the X-axis direction and the Y-axis direction) perpendicular to the optical axis direction (the Z-axis direction) with respect to the support member 8 by at least the three lower guide mechanisms LGM, as illustrated in FIG. 5. More particularly, the lower guide mechanism LGM includes the lower guiding part LGD (refer to FIG. 7) provided on the support member 8, and the lower guided part LGE (refer to FIG. 5) provided on the base member 3. The support member 8 includes the support-side magnetic member SM, and the base-side magnetic member BM is formed of a magnet. As illustrated in FIG. 12, the base-side magnetic member BM and the support-side magnetic member SM are configured so that the lower guiding part LGD and the lower guided part LGE press against each other due to the magnetic force IMF acting between the base-side magnetic member BM and the support-side magnetic member SM. In the illustrated example, the lower guiding part LGD is the contact portion 8T provided on the upper surface of the base portion 8B of the support member 8, and the lower guided part LGE is the exposed portion (the portion exposed at the lower surface of the base member 3) of the metal embedded member 30 embedded in the base member 3, as illustrated in FIG. 13. However, the lower guided part LGE may be a part of a member formed of a synthetic resin, such as a part of the lower surface of the base member 3 or the like. Particularly, as illustrated in FIG. 12, the first base-side magnetic member BM1 and the support-side magnetic member SM are configured so that the lower guiding part LGD and the lower guided part LGE press against each other due to the first magnetic force LMF1 acting between the first base-side magnetic member BM1 and the support-side magnetic member SM. As illustrated in FIG. 12, the second base-side magnetic member BM2 and the support-side magnetic member SM are configured so that the lower guiding part LGD and the lower guided part LGE press against each other due to the second magnetic force LMF2 acting between the second base-side magnetic member BM2 and the support-side magnetic member SM.

This configuration provides an effect of utilizing the base-side magnetic member BM not only for attracting the lens-side magnetic member LM, but also for attracting the support-side magnetic member SM.

According to the embodiments of the present disclosure, the lens driving device can more stably move the lens holding member along the optical axis direction.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures. Each of the features described with reference to the embodiments described above and below may be combined as appropriate, provided that no technical contradictions occur.

For example, in the embodiment described above, the metal member 5 is fixed to each member (each of the lens holding member 2, the base member 3, and the support member 8) using an adhesive or the like, but the metal member 5 may be embedded in each member or may be composed of a conductive pattern formed on the surface of each member.

Moreover, in the embodiment described above, the lens-side magnetic member LM, the base-side magnetic member BM, and the support-side magnetic member SM are bonded to and fixed on the lens holding member 2, the base member 3, and the support member 8, respectively, but may be composed of magnetic metals embedded in the respective members.

Further, in the embodiment described above, the lower guiding part LGD is formed by the contact portion 8T provided on the upper surface of the support member 8, and the lower guided part LGE is formed by a part of the embedded member 30 embedded in the base member 3. However, the lower guided part LGE may be a contact portion (a part of the base member 3 projecting downward and having a shape that is a combination of a cylinder and a hemisphere) provided on the lower surface of the base member 3, and the lower guided part LGD may be a part of a metal member embedded in the support member 8.

What is claimed is:

1. A lens driving device comprising:
a base member;
a lens holding member having a tubular part configured to hold a lens system; and
a shape memory alloy wire, provided between the base member and the lens holding member, configured to move the lens holding member in an optical axis direction, wherein:
the shape memory alloy wire has a first end supported on the base member and a second end supported on the lens holding member, so that the first end and the second end are located at different positions along the optical axis direction,
the base member has a guiding part configured to guide the lens holding member to move in the optical axis direction,
the lens holding member has a guided part guided by the guiding part, and
a pressing force acts on the guiding part and the guided part to press against each other due to contraction of the shape memory alloy wire in response to a current applied to the shape memory alloy wire, so that the guided part slides along the guiding part.

2. The lens driving device as claimed in claim 1, wherein:
the base member includes a base-side magnetic member provided on the base side,
the lens holding member includes a lens-side magnetic member provided on the lens side,
at least one of the base-side magnetic member and the lens-side magnetic member is composed of a magnet, and
a magnetic force acts between the base-side magnetic member and the lens-side magnetic member so as to reduce the pressing force when the current is applied to the shape memory alloy wire.

3. The lens driving device as claimed in claim 2, wherein:
the base member includes a base-side metal member provided on the base side and fixed to the first end of the shape memory alloy wire,
the lens holding member includes a lens-side metal member provided on the lens side and fixed to the second end of the shape memory alloy wire, and
the guiding part and the guided part are arranged at positions closer to the lens-side metal member than to the base-side metal member.

4. The lens driving device as claimed in claim 3, wherein:
the lens-side metal member is formed by a metal plate having a plate-shaped base,
the lens holding member includes an attachment wall to which the lens-side metal member is attached, and a guided wall formed along a plane intersecting a plane along a plate surface of the base of the lens-side metal member,
the guided part is formed on an inner surface of the guided wall, and the lens-side magnetic member is fixed to an outer surface of the guided wall,
the base member includes an outer wall arranged outside the guided wall, and the base-side magnetic member is fixed to the outer wall, and
the base-side magnetic member is composed of a magnet.

5. The lens driving device as claimed in claim 4, wherein:
a penetration part, penetrating a space surrounded by an annular pedestal including the attachment wall and the guided wall in the optical axis direction, is formed at an outer side of the tubular part,
the base member has a projection inserted into the penetration part, and
the projection is provided with the guiding part.

6. The lens driving device as claimed in claim 1, further comprising:
a pair of guide mechanisms having an optical axis arranged therebetween,
each guide mechanism of the pair of guide mechanisms is composed of a combination of the guiding part and the guided part, and
each guide mechanism of the pair of guide mechanisms is provided with a plurality of the shape memory alloy wires corresponding thereto.

7. The lens driving device as claimed in claim 2, wherein:
the base member has a plate-shaped main body,
the lens holding member is arranged on one side of the main body, and the support member is arranged on the other side of the main body,
the main body of the base member is movable in a direction perpendicular to the optical axis direction with respect to the support member, and
another shape memory alloy wire configured to move the base member in a direction perpendicular to the optical axis direction is provided between the base member and the support member.

8. The lens driving device as claimed in claim 7, wherein:
the main body of the base member is configured to be movable in a direction perpendicular to the optical axis direction with respect to the support member, by at least three lower guide mechanisms,
each lower guide mechanism of the at least three lower guide mechanisms has a lower guiding part provided on the support member, and a lower guided part provided on the base member,
the support member includes a support-side magnetic member,
the base-side magnetic member is composed of a magnet, and
the base-side magnetic member and the support-side magnetic member are configured so that the lower guiding part and the lower guided part press against each other due to a magnetic force acting between the base-side magnetic member and the support-side magnetic member.

9. A camera module comprising:
a lens driving device according to claim 1;
the lens system fixed to the lens holding member; and
an image sensor opposing the lens system.

10. A camera module comprising:
a lens driving device according to claim 2;
the lens system fixed to the lens holding member; and
an image sensor opposing the lens system.
